(19) United States
(12) Patent Application Publication
(10) Pub. No.: US 2026/0214708 A1
(43) Pub. Date: Jul. 23, 2026

(54) METHOD AND DEVICE FOR TRANSMITTING/RECEIVING RELAY FRAME IN WIRELESS LAN SYSTEM

(71) Applicant: LG ELECTRONICS INC., Seoul (KR)

(72) Inventors: Dongguk LIM, Seoul (KR); Jinyoung CHUN, Seoul (KR); Jinsoo CHOI, Seoul (KR); Eunsung PARK, Seoul (KR); Insun JANG, Seoul (KR)

(73) Assignee: LG ELECTRONICS INC., Seoul (KR)

(21) Appl. No.: 19/135,743

(22) PCT Filed: Dec. 12, 2023
(86) PCT No.: PCT/KR2023/020384

§ 371 Date: Jun. 4, 2025

(30) Foreign Application Priority Data
Dec. 14, 2022 (KR) 10-2022-0175141

(51) Int. Cl. H04W 74/0816; H04W 8/22; H04W 80/02

(52) U.S. Cl. CPC H04W 74/0816; H04W 8/22; H04W 80/02

(57) ABSTRACT

A method and a device for transmitting/receiving a relay frame in a wireless LAN system are disclosed. The method performed by means of a first station (STA) in the wireless LAN system, according to one embodiment of the present disclosure, may comprise the steps of: negotiating, with an access point (AP), about relay transmission; receiving, from the AP, a data frame targeting one or more second STAs; and transmitting the data frame to the one or more second STAs. Here, the MAC header in the data frame includes information indicating that the data frame is transmitted/received through a relay, and at least one from among a plurality of address fields included in the MAC header can be set as identification information about the first STA.

### CROSS-REFERENCE TO RELATED APPLICATION(S)

This application is the National Stage filing under 35 U.S.C. 371 of International Application No. PCT/KR2023/020384, filed on Dec. 12, 2023, which claims the benefit of earlier filing date and right of priority to Korean Application No. 10-2022-0175141, filed on Dec. 14, 2022, the contents of which are all incorporated by reference herein in their entirety.

### TECHNICAL FIELD

The present disclosure relates to a method and device for transmitting and receiving a relay frame in a wireless local area network (WLAN) system.

### BACKGROUND

New technologies for improving transmission rates, increasing bandwidth, improving reliability, reducing errors, and reducing latency have been introduced for a wireless LAN (WLAN). Among WLAN technologies, an Institute of Electrical and Electronics Engineers (IEEE) 802.11 series standard may be referred to as Wi-Fi. For example, technologies recently introduced to WLAN include enhancements for Very High-Throughput (VHT) of the 802.11ac standard, and enhancements for High Efficiency (HE) of the IEEE 802.11ax standard.

In order to provide a more advanced wireless communication environment, improved technologies for Extremely High Throughput (EHT) are being discussed. For example, technologies for MIMO and multiple access point (AP) coordination that support increased bandwidth, efficient utilization of multiple bands, and increased spatial streams are being studied, and in particular, various technologies are being studied to support low latency or real-time traffic. Furthermore, new technologies are being discussed to support ultra high reliability (UHR), including improvements or extensions of EHT technologies.

### SUMMARY

A technical object of the present disclosure is to provide a method and device for transmitting and receiving a relay frame in a wireless local area network (WLAN) system.

A technical object of the present disclosure is to provide a method and device for transmitting and receiving a relay frame through a relay STA controlled by an AP in a wireless LAN system.

The technical objects to be achieved by the present disclosure are not limited to the above-described technical objects, and other technical objects which are not described herein will be clearly understood by those skilled in the pertinent art from the following description.

A method performed by a first station (STA) in a wireless LAN system according to an aspect of the present disclosure may comprise: performing negotiation with an access point (AP) for relay transmission; receiving, from the AP, a data frame targeting one or more second STAs; and transmitting the data frame to the one or more second STAs. Herein, a medium access control (MAC) header in the data frame may include information for that the data frame is transmitted and received through a relay, and at least one of a plurality of address fields included in the MAC header may be set to identification information for the first STA.

A method performed by an access point (AP) in a wireless LAN system according to an additional aspect of the present disclosure may comprise: performing negotiation with a first station (STA) for relay transmission; constructing a data frame targeting one or more second STAs, for the relay transmission; and transmitting the data frame to the first STA. Herein, a medium access control (MAC) header in the data frame may include information for that the data frame is transmitted and received through a relay, and at least one of a plurality of address fields included in the MAC header may be set to identification information for the first STA.

According to the present disclosure, a method and device for transmitting and receiving a relay frame in a wireless local area network (WLAN) system may be provided.

According to the present disclosure, a method and device for transmitting and receiving a relay frame through a relay STA controlled by an AP in a wireless LAN system may be provided.

According to the present disclosure, by performing signal transmission to an STA using a relay method, the influence of range and obstacles may be reduced and the reception quality (e.g., received SNR) of the STA may be improved, thereby providing a technical effect of reducing latency for signal transmission and improving throughput.

Effects achievable by the present disclosure are not limited to the above-described effects, and other effects which are not described herein may be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates a block configuration diagram of a wireless communication device according to an embodiment of the present disclosure.

FIG. 2 is a diagram illustrating an exemplary structure of a WLAN system to which the present disclosure may be applied.

FIG. 3 is a diagram for describing a link setup process to which the present disclosure may be applied.

FIG. 4 is a diagram for describing a backoff process to which the present disclosure may be applied.

FIG. 5 is a diagram for describing a frame transmission operation based on CSMA/CA to which the present disclosure may be applied.

FIG. 6 is a diagram for describing an example of a frame structure used in a WLAN system to which the present disclosure may be applied.

FIG. 7 is a diagram illustrating examples of PPDUs defined in the IEEE 802.11 standard to which the present disclosure may be applied.

FIG. 8 illustrates a relay transmission structure according to an embodiment of the present disclosure.

FIG. 9 illustrates an A-MSDU-based frame format of relay transmission for an individual non-AP STA according to an embodiment of the present disclosure.

FIG. 10 illustrates an A-MSDU-based frame format of relay transmission for multiple non-AP STAs or grouped non-AP STAs according to an embodiment of the present disclosure.

FIG. 11 illustrates an A-MPDU-based frame format of relay transmission for an individual non-AP STA according to an embodiment of the present disclosure.

FIG. 12 illustrates an A-MPDU-based frame format of relay transmission for multiple non-AP STAs or grouped non-AP STAs according to an embodiment of the present disclosure.

FIG. 13 illustrates an operation flowchart by a first STA according to an embodiment of the present disclosure.

FIG. 14 illustrates an operation flowchart by an AP according to an embodiment of the present disclosure.

### DETAILED DESCRIPTION

Hereinafter, embodiments according to the present disclosure will be described in detail by referring to accompanying drawings. Detailed description to be disclosed with accompanying drawings is to describe exemplary embodiments of the present disclosure and is not to represent the only embodiment that the present disclosure may be implemented. The following detailed description includes specific details to provide complete understanding of the present disclosure. However, those skilled in the pertinent art knows that the present disclosure may be implemented without such specific details.

In some cases, known structures and devices may be omitted or may be shown in a form of a block diagram based on a core function of each structure and device in order to prevent a concept of the present disclosure from being ambiguous.

In the present disclosure, when an element is referred to as being “connected”, “combined” or “linked” to another element, it may include an indirect connection relation that yet another element presents therebetween as well as a direct connection relation. In addition, in the present disclosure, a term, “include” or “have”, specifies the presence of a mentioned feature, step, operation, component and/or element, but it does not exclude the presence or addition of one or more other features, stages, operations, components, elements and/or their groups.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

A term used in the present disclosure is to describe a specific embodiment, and is not to limit a claim. As used in a described and attached claim of an embodiment, a singular form is intended to include a plural form, unless the context clearly indicates otherwise. A term used in the present disclosure, “and/or”, may refer to one of related enumerated items or it means that it refers to and includes any and all possible combinations of two or more of them. In addition, “/” between words in the present disclosure has the same meaning as “and/or”, unless otherwise described.

Examples of the present disclosure may be applied to various wireless communication systems. For example, examples of the present disclosure may be applied to a wireless LAN system. For example, examples of the present disclosure may be applied to an IEEE 802.11a/g/n/ac/ax standards-based wireless LAN. Furthermore, examples of the present disclosure may be applied to a wireless LAN based on the newly proposed IEEE 802.11be (or EHT) standard. Examples of the present disclosure may be applied to an IEEE 802.11be Release-2 standard-based wireless LAN corresponding to an additional enhancement technology of the IEEE 802.11be Release-1 standard. Additionally, examples of the present disclosure may be applied to a next-generation standards-based wireless LAN after IEEE 802.11be. Further, examples of this disclosure may be applied to a cellular wireless communication system. For example, it may be applied to a cellular wireless communication system based on Long Term Evolution (LTE)-based technology and 5G New Radio (NR)-based technology of the 3rd Generation Partnership Project (3GPP) standard.

Hereinafter, technical features to which examples of the present disclosure may be applied will be described.

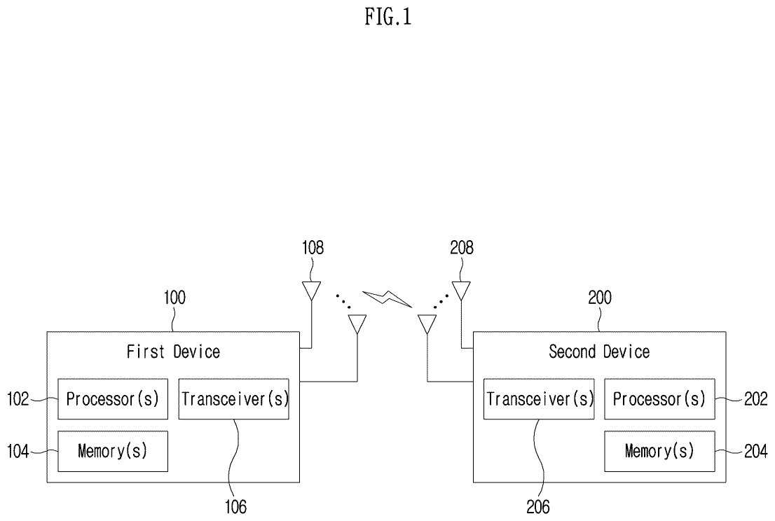

FIG. 1 illustrates a block diagram of a wireless communication device according to an embodiment of the present disclosure.

The first device 100 and the second device 200 illustrated in FIG. 1 may be replaced with various terms such as a terminal, a wireless device, a Wireless Transmit Receive Unit (WTRU), an User Equipment (UE), a Mobile Station (MS), an user terminal (UT), a Mobile Subscriber Station (MSS), a Mobile Subscriber Unit (MSU), a subscriber station (SS), an advanced mobile station (AMS), a wireless terminal (WT), or simply user, etc. In addition, the first device 100 and the second device 200 include an access point (AP), a base station (BS), a fixed station, a Node B, a base transceiver system (BTS), a network, It may be replaced with various terms such as an Artificial Intelligence (AI) system, a road side unit (RSU), a repeater, a router, a relay, and a gateway.

The devices 100 and 200 illustrated in FIG. 1 may be referred to as stations (STAs). For example, the devices 100 and 200 illustrated in FIG. 1 may be referred to by various terms such as a transmitting device, a receiving device, a transmitting STA, and a receiving STA. For example, the STAs 110 and 200 may perform an access point (AP) role or a non-AP role. That is, in the present disclosure, the STAs 110 and 200 may perform functions of an AP and/or a non-AP. When the STAs 110 and 200 perform an AP function, they may be simply referred to as APs, and when the STAs 110 and 200 perform non-AP functions, they may be simply referred to as STAs. In addition, in the present disclosure, an AP may also be indicated as an AP STA.

Referring to FIG. 1, the first device 100 and the second device 200 may transmit and receive radio signals through various wireless LAN technologies (e.g., IEEE 802.11 series). The first device 100 and the second device 200 may include an interface for a medium access control (MAC) layer and a physical layer (PHY) conforming to the IEEE 802.11 standard.

In addition, the first device 100 and the second device 200 may additionally support various communication standards (e.g., 3GPP LTE series, 5G NR series standards, etc.) technologies other than wireless LAN technology. In addition, the device of the present disclosure may be implemented in various devices such as a mobile phone, a vehicle, a personal computer, augmented reality (AR) equipment, and virtual reality (VR) equipment, etc. In addition, the STA of the present specification may support various communication services such as a voice call, a video call, data communication, autonomous-driving, machine-type communication (MTC), machine-to-machine (M2M), device-to-device (D2D), IoT (Internet-of-Things), etc.

A first device 100 may include one or more processors 102 and one or more memories 104 and may additionally include one or more transceivers 106 and/or one or more antennas 108. A processor 102 may control a memory 104 and/or a transceiver 106 and may be configured to implement description, functions, procedures, proposals, methods and/or operation flow charts disclosed in the present disclosure. For example, a processor 102 may transmit a wireless signal including first information/signal through a transceiver 106 after generating first information/signal by processing information in a memory 104. In addition, a processor 102 may receive a wireless signal including second information/signal through a transceiver 106 and then store information obtained by signal processing of second information/signal in a memory 104. A memory 104 may be connected to a processor 102 and may store a variety of information related to an operation of a processor 102. For example, a memory 104 may store a software code including instructions for performing all or part of processes controlled by a processor 102 or for performing description, functions, procedures, proposals, methods and/or operation flow charts disclosed in the present disclosure. Here, a processor 102 and a memory 104 may be part of a communication modem/circuit/chip designed to implement a wireless LAN technology (e.g., IEEE 802.11 series). A transceiver 106 may be connected to a processor 102 and may transmit and/or receive a wireless signal through one or more antennas 108. A transceiver 106 may include a transmitter and/or a receiver. A transceiver 106 may be used together with a RF (Radio Frequency) unit. In the present disclosure, a device may mean a communication modem/circuit/chip.

A second device 200 may include one or more processors 202 and one or more memories 204 and may additionally include one or more transceivers 206 and/or one or more antennas 208. A processor 202 may control a memory 204 and/or a transceiver 206 and may be configured to implement description, functions, procedures, proposals, methods and/or operation flows charts disclosed in the present disclosure. For example, a processor 202 may generate third information/signal by processing information in a memory 204, and then transmit a wireless signal including third information/signal through a transceiver 206. In addition, a processor 202 may receive a wireless signal including fourth information/signal through a transceiver 206, and then store information obtained by signal processing of fourth information/signal in a memory 204. A memory 204 may be connected to a processor 202 and may store a variety of information related to an operation of a processor 202. For example, a memory 204 may store a software code including instructions for performing all or part of processes controlled by a processor 202 or for performing description, functions, procedures, proposals, methods and/or operation flow charts disclosed in the present disclosure. Here, a processor 202 and a memory 204 may be part of a communication modem/circuit/chip designed to implement a wireless LAN technology (e.g., IEEE 802.11 series). A transceiver 206 may be connected to a processor 202 and may transmit and/or receive a wireless signal through one or more antennas 208. A transceiver 206 may include a transmitter and/or a receiver. A transceiver 206 may be used together with a RF unit. In the present disclosure, a device may mean a communication modem/circuit/chip.

Hereinafter, a hardware element of a device 100, 200 will be described in more detail. It is not limited thereto, but one or more protocol layers may be implemented by one or more processors 102, 202. For example, one or more processors 102, 202 may implement one or more layers (e.g., a functional layer such as PHY, MAC). One or more processors 102, 202 may generate one or more PDUs (Protocol Data Unit) and/or one or more SDUs (Service Data Unit) according to description, functions, procedures, proposals, methods and/or operation flow charts disclosed in the present disclosure. One or more processors 102, 202 may generate a message, control information, data or information according to description, functions, procedures, proposals, methods and/or operation flow charts disclosed in the present disclosure. One or more processors 102, 202 may generate a signal (e.g., a baseband signal) including a PDU, a SDU, a message, control information, data or information according to functions, procedures, proposals and/or methods disclosed in the present disclosure to provide it to one or more transceivers 106, 206. One or more processors 102, 202 may receive a signal (e.g., a baseband signal) from one or more transceivers 106, 206 and obtain a PDU, a SDU, a message, control information, data or information according to description, functions, procedures, proposals, methods and/or operation flow charts disclosed in the present disclosure.

One or more processors 102, 202 may be referred to as a controller, a micro controller, a micro processor or a micro computer. One or more processors 102, 202 may be implemented by a hardware, a firmware, a software, or their combination. In an example, one or more ASICs (Application Specific Integrated Circuit), one or more DSPs (Digital Signal Processor), one or more DSPDs (Digital Signal Processing Device), one or more PLDs (Programmable Logic Device) or one or more FPGAs (Field Programmable Gate Arrays) may be included in one or more processors 102, 202. Description, functions, procedures, proposals, methods and/or operation flow charts disclosed in the present disclosure may be implemented by using a firmware or a software and a firmware or a software may be implemented to include a module, a procedure, a function, etc. A firmware or a software configured to perform description, functions, procedures, proposals, methods and/or operation flow charts disclosed in the present disclosure may be included in one or more processors 102, 202 or may be stored in one or more memories 104, 204 and driven by one or more processors 102, 202. Description, functions, procedures, proposals, methods and/or operation flow charts disclosed in the present disclosure may be implemented by using a firmware or a software in a form of a code, an instruction and/or a set of instructions.

One or more memories 104, 204 may be connected to one or more processors 102, 202 and may store data, a signal, a message, information, a program, a code, an indication and/or an instruction in various forms. One or more memories 104, 204 may be configured with ROM, RAM, EPROM, a flash memory, a hard drive, a register, a cash memory, a computer readable storage medium and/or their combination. One or more memories 104, 204 may be positioned inside and/or outside one or more processors 102, 202. In addition, one or more memories 104, 204 may be connected to one or more processors 102, 202 through a variety of technologies such as a wire or wireless connection.

One or more transceivers 106, 206 may transmit user data, control information, a wireless signal/channel, etc. mentioned in methods and/or operation flow charts, etc. of the present disclosure to one or more other devices. One or more transceivers 106, 206 may receiver user data, control information, a wireless signal/channel, etc. mentioned in description, functions, procedures, proposals, methods and/or operation flow charts, etc. disclosed in the present disclosure from one or more other devices. For example, one or more transceivers 106, 206 may be connected to one or more processors 102, 202 and may transmit and receive a wireless signal. For example, one or more processors 102, 202 may control one or more transceivers 106, 206 to transmit user data, control information or a wireless signal to one or more other devices. In addition, one or more processors 102, 202 may control one or more transceivers 106, 206 to receive user data, control information or a wireless signal from one or more other devices. In addition, one or more transceivers 106, 206 may be connected to one or more antennas 108, 208 and one or more transceivers 106, 206 may be configured to transmit and receive user data, control information, a wireless signal/channel, etc. mentioned in description, functions, procedures, proposals, methods and/or operation flow charts, etc. disclosed in the present disclosure through one or more antennas 108, 208. In the present disclosure, one or more antennas may be a plurality of physical antennas or a plurality of logical antennas (e.g., an antenna port). One or more transceivers 106, 206 may convert a received wireless signal/channel, etc. into a baseband signal from a RF band signal to process received user data, control information, wireless signal/channel, etc. by using one or more processors 102, 202. One or more transceivers 106, 206 may convert user data, control information, a wireless signal/channel, etc. which are processed by using one or more processors 102, 202 from a baseband signal to a RF band signal. Therefore, one or more transceivers 106, 206 may include an (analogue) oscillator and/or a filter.

For example, one of the STAs 100 and 200 may perform an intended operation of an AP, and the other of the STAs 100 and 200 may perform an intended operation of a non-AP STA. For example, the transceivers 106 and 206 of FIG. 1 may perform a transmission and reception operation of a signal (e.g., a packet or a physical layer protocol data unit (PPDU) conforming to IEEE 802.11a/b/g/n/ac/ax/be). In addition, in the present disclosure, an operation in which various STAs generate transmission/reception signals or perform data processing or calculation in advance for transmission/reception signals may be performed by the processors 102 and 202 of FIG. 1. For example, an example of an operation of generating a transmission/reception signal or performing data processing or calculation in advance for the transmission/reception signal may include 1) determining/acquiring/configuring/calculating/decoding/encoding bit information of fields (signal (SIG), short training field (STF), long training field (LTF), Data, etc.) included in the PPDU, 2) determining/configuring/acquiring time resources or frequency resources (e.g., subcarrier resources) used for fields (SIG, STF, LTF, Data, etc.) included in the PPDU; 3) determining/configuring/acquiring a specific sequence (e.g., pilot sequence, STF/LTF sequence, extra sequence applied to SIG) used for fields (SIG, STF, LTF, Data, etc.) included in the PPDU action, 4) power control operation and/or power saving operation applied to the STA, 5) Operations related to ACK signal determination/acquisition/configuration/calculation/decoding/encoding, etc. In addition, in the following example, various information (e.g., information related to fields/subfields/control fields/parameters/power, etc.) used by various STAs to determine/acquire/configure/calculate/decode/encode transmission and reception signals may be stored in the memories 104 and 204 of FIG. 1.

Hereinafter, downlink (DL) may mean a link for communication from an AP STA to a non-AP STA, and a DL PPDU/packet/signal may be transmitted and received through the DL. In DL communication, a transmitter may be part of an AP STA, and a receiver may be part of a non-AP STA. Uplink (UL) may mean a link for communication from non-AP STAs to AP STAs, and a UL PPDU/packet/signal may be transmitted and received through the UL. In UL communication, a transmitter may be part of a non-AP STA, and a receiver may be part of an AP STA.

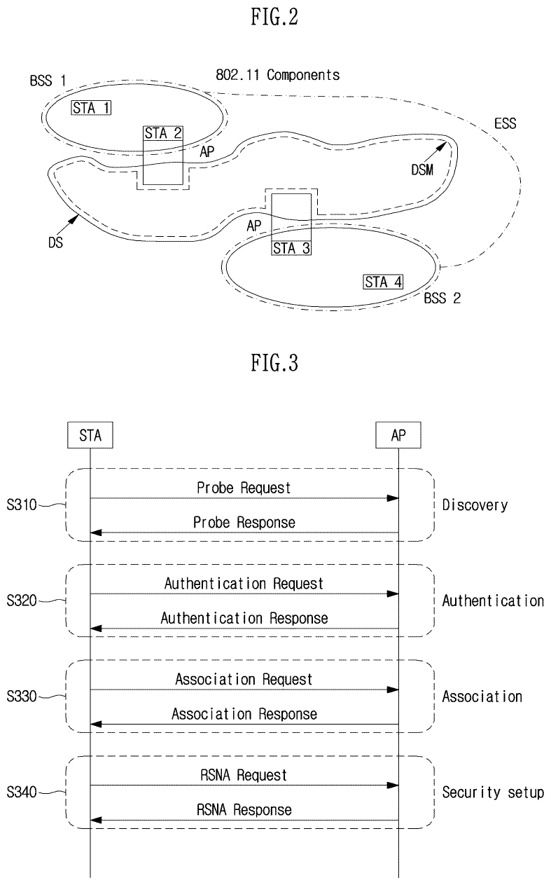

FIG. 2 is a diagram illustrating an exemplary structure of a wireless LAN system to which the present disclosure may be applied.

The structure of the wireless LAN system may consist of be composed of a plurality of components. A wireless LAN supporting STA mobility transparent to an upper layer may be provided by interaction of a plurality of components. A Basic Service Set (BSS) corresponds to a basic construction block of a wireless LAN. FIG. 2 exemplarily shows that two BSSs (BSS1 and BSS2) exist and two STAs are included as members of each BSS (STA1 and STA2 are included in BSS1, and STA3 and STA4 are included in BSS2). An ellipse representing a BSS in FIG. 2 may also be understood as representing a coverage area in which STAs included in the corresponding BSS maintain communication. This area may be referred to as a Basic Service Area (BSA). When an STA moves out of the BSA, it may not directly communicate with other STAs within the BSA.

If the DS shown in FIG. 2 is not considered, the most basic type of BSS in a wireless LAN is an independent BSS (IBSS). For example, IBSS may have a minimal form containing only two STAs. For example, assuming that other components are omitted, BSS1 containing only STA1 and STA2 or BSS2 containing only STA3 and STA4 may respectively correspond to representative examples of IBSS. This configuration is possible when STAs may communicate directly without an AP. In addition, in this type of wireless LAN, it is not configured in advance, but may be configured when a LAN is required, and this may be referred to as an ad-hoc network. Since the IBSS does not include an AP, there is no centralized management entity. That is, in IBSS, STAs are managed in a distributed manner. In IBSS, all STAs may be made up of mobile STAs, and access to the distributed system (DS) is not allowed, forming a self-contained network.

Membership of an STA in the BSS may be dynamically changed by turning on or off the STA, entering or exiting the BSS area, and the like. To become a member of the BSS, the STA may join the BSS using a synchronization process. In order to access all services of the BSS infrastructure, the STA shall be associated with the BSS. This association may be dynamically established and may include the use of a Distribution System Service (DSS).

A direct STA-to-STA distance in a wireless LAN may be limited by PHY performance. In some cases, this distance limit may be sufficient, but in some cases, communication between STAs at a longer distance may be required. A distributed system (DS) may be configured to support extended coverage.

DS means a structure in which BSSs are interconnected. Specifically, as shown in FIG. 2, a BSS may exist as an extended form of a network composed of a plurality of BSSs. DS is a logical concept and may be specified by the characteristics of Distributed System Media (DSM). In this regard, a wireless medium (WM) and a DSM may be logically separated. Each logical medium is used for a different purpose and is used by different components. These medium are not limited to being the same, nor are they limited to being different. In this way, the flexibility of the wireless LAN structure (DS structure or other network structure) may be explained in that a plurality of media are logically different. That is, the wireless LAN structure may be implemented in various ways, and the corresponding wireless LAN structure may be independently specified by the physical characteristics of each embodiment.

A DS may support a mobile device by providing seamless integration of a plurality of BSSs and providing logical services necessary to address an address to a destination. In addition, the DS may further include a component called a portal that serves as a bridge for connection between the wireless LAN and other networks (e.g., IEEE 802.X).

The AP enables access to the DS through the WM for the associated non-AP STAs, and means an entity that also has the functionality of an STA. Data movement between the BSS and the DS may be performed through the AP. For example, STA2 and STA3 shown in FIG. 2 have the functionality of STAs, and provide a function allowing the associated non-AP STAs (STA1 and STA4) to access the DS. In addition, since all APs basically correspond to STAs, all APs are addressable entities. The address used by the AP for communication on the WM and the address used by the AP for communication on the DSM are not necessarily the same. A BSS composed of an AP and one or more STAs may be referred to as an infrastructure BSS.

Data transmitted from one of the STA(s) associated with an AP to a STA address of the corresponding AP may be always received on an uncontrolled port and may be processed by an IEEE 802.1X port access entity. In addition, when a controlled port is authenticated, transmission data (or frames) may be delivered to the DS.

In addition to the structure of the DS described above, an extended service set (ESS) may be configured to provide wide coverage.

An ESS means a network in which a network having an arbitrary size and complexity is composed of DSs and BSSs. The ESS may correspond to a set of BSSs connected to one DS. However, the ESS does not include the DS. An ESS network is characterized by being seen as an IBSS in the Logical Link Control (LLC) layer. STAs included in the ESS may communicate with each other, and mobile STAs may move from one BSS to another BSS (within the same ESS) transparently to the LLC. APs included in one ESS may have the same service set identification (SSID). The SSID is distinguished from the BSSID, which is an identifier of the BSS.

The wireless LAN system does not assume anything about the relative physical locations of BSSs, and all of the following forms are possible. BSSs may partially overlap, which is a form commonly used to provide continuous coverage. In addition, BSSs may not be physically connected, and logically there is no limit on the distance between BSSs. In addition, the BSSs may be physically located in the same location, which may be used to provide redundancy. In addition, one (or more than one) IBSS or ESS networks may physically exist in the same space as one (or more than one) ESS network. When an ad-hoc network operates in a location where an ESS network exists, when physically overlapping wireless networks are configured by different organizations, or when two or more different access and security policies are required in the same location, this may correspond to the form of an ESS network in the like.

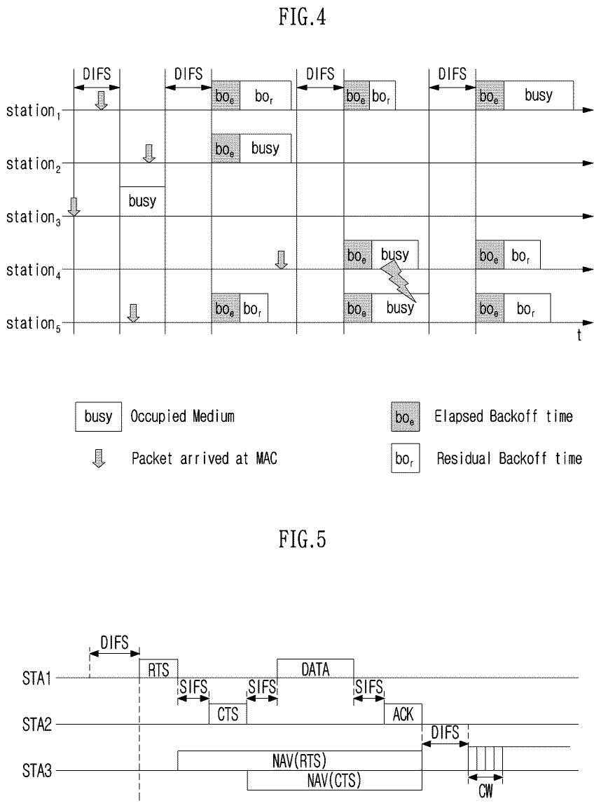

FIG. 3 is a diagram for explaining a link setup process to which the present disclosure may be applied.

In order for an STA to set up a link with respect to a network and transmit/receive data, it first discovers a network, performs authentication, establishes an association, and need to perform the authentication process for security. The link setup process may also be referred to as a session initiation process or a session setup process. In addition, the processes of discovery, authentication, association, and security setting of the link setup process may be collectively referred to as an association process.

In step S310, the STA may perform a network discovery operation. The network discovery operation may include a scanning operation of the STA. That is, in order for the STA to access the network, it needs to find a network in which it can participate. The STA shall identify a compatible network before participating in a wireless network, and the process of identifying a network existing in a specific area is called scanning.

Scanning schemes include active scanning and passive scanning. FIG. 3 exemplarily illustrates a network discovery operation including an active scanning process. In active scanning, an STA performing scanning transmits a probe request frame to discover which APs exist around it while moving channels and waits for a response thereto. A responder transmits a probe response frame as a response to the probe request frame to the STA that has transmitted the probe request frame. Here, the responder may be an STA that last transmitted a beacon frame in the BSS of the channel being scanned. In the BSS, since the AP transmits the beacon frame, the AP becomes a responder, and in the IBSS, the STAs in the IBSS rotate to transmit the beacon frame, so the responder is not constant. For example, a STA that transmits a probe request frame on channel 1 and receives a probe response frame on channel 1, may store BSS-related information included in the received probe response frame and may move to the next channel (e.g., channel 2) and perform scanning (i.e., transmission/reception of a probe request/response on channel 2) in the same manner.

Although not shown in FIG. 3, the scanning operation may be performed in a passive scanning manner. In passive scanning, a STA performing scanning waits for a beacon frame while moving channels. The beacon frame is one of the management frames defined in IEEE 802.11, and is periodically transmitted to notify the existence of a wireless network and to allow the STA performing scanning to find a wireless network and participate in the wireless network. In the BSS, the AP serves to transmit beacon frames periodically, and in the IBSS, STAs within the IBSS rotate to transmit beacon frames. When the STA performing scanning receives a beacon frame, the STA stores information for the BSS included in the beacon frame and records beacon frame information in each channel while moving to another channel. The STA receiving the beacon frame may store BSS-related information included in the received beacon frame, move to the next channel, and perform scanning in the next channel in the same way. Comparing active scanning and passive scanning, active scanning has an advantage of having less delay and less power consumption than passive scanning.

After the STA discovers the network, an authentication process may be performed in step S320. This authentication process may be referred to as a first authentication process in order to be clearly distinguished from the security setup operation of step S340 to be described later.

The authentication process includes a process in which the STA transmits an authentication request frame to the AP, and in response to this, the AP transmits an authentication response frame to the STA. An authentication frame used for authentication request/response corresponds to a management frame.

The authentication frame includes an authentication algorithm number, an authentication transaction sequence number, a status code, a challenge text, a robust security network (RSN), and a Finite Cyclic Group, etc. This corresponds to some examples of information that may be included in the authentication request/response frame, and may be replaced with other information or additional information may be further included.

The STA may transmit an authentication request frame to the AP. The AP may determine whether to allow authentication of the corresponding STA based on information included in the received authentication request frame. The AP may provide the result of the authentication process to the STA through an authentication response frame.

After the STA is successfully authenticated, an association process may be performed in step S330. The association process includes a process in which the STA transmits an association request frame to the AP, and in response, the AP transmits an association response frame to the STA.

For example, the association request frame may include information related to various capabilities, a beacon listen interval, a service set identifier (SSID), supported rates, supported channels, RSN, mobility domain, supported operating classes, Traffic Indication Map Broadcast request (TIM broadcast request), interworking service capability, etc. For example, the association response frame may include information related to various capabilities, status code, association ID (AID), supported rates, enhanced distributed channel access (EDCA) parameter set, received channel power indicator (RCPI), received signal to noise indicator (RSNI), mobility domain, timeout interval (e.g., association comeback time), overlapping BSS scan parameters, TIM broadcast response, Quality of Service (QoS) map, etc. This corresponds to some examples of information that may be included in the association request/response frame, and may be replaced with other information or additional information may be further included.

After the STA is successfully associated with the network, a security setup process may be performed in step S340. The security setup process of step S340 may be referred to as an authentication process through Robust Security Network Association (RSNA) request/response, and the authentication process of step S320 is referred to as a first authentication process, and the security setup process of step S340 may also simply be referred to as an authentication process.

The security setup process of step S340 may include, for example, a process of setting up a private key through 4-way handshaking through an Extensible Authentication Protocol over LAN (EAPOL) frame. In addition, the security setup process may be performed according to a security scheme not defined in the IEEE 802.11 standard.

FIG. 4 is a diagram for explaining a backoff process to which the present disclosure may be applied.

In the wireless LAN system, a basic access mechanism of medium access control (MAC) is a carrier sense multiple access with collision avoidance (CSMA/CA) mechanism. The CSMA/CA mechanism is also called Distributed Coordination Function (DCF) of IEEE 802.11 MAC, and basically adopts a “listen before talk” access mechanism. According to this type of access mechanism, the AP and/or STA may perform Clear Channel Assessment (CCA) sensing a radio channel or medium during a predetermined time interval (e.g., DCF Inter-Frame Space (DIFS)), prior to starting transmission. As a result of the sensing, if it is determined that the medium is in an idle state, frame transmission is started through the corresponding medium. On the other hand, if it is detected that the medium is occupied or busy, the corresponding AP and/or STA does not start its own transmission and may set a delay period for medium access (e.g., a random backoff period) and attempt frame transmission after waiting. By applying the random backoff period, since it is expected that several STAs attempt frame transmission after waiting for different periods of time, collision may be minimized.

In addition, the IEEE 802.11 MAC protocol provides a Hybrid Coordination Function (HCF). HCF is based on the DCF and Point Coordination Function (PCF). PCF is a polling-based synchronous access method and refers to a method in which all receiving APs and/or STAs periodically poll to receive data frames. In addition, HCF has Enhanced Distributed Channel Access (EDCA) and HCF Controlled Channel Access (HCCA). EDCA is a contention-based access method for a provider to provide data frames to multiple users, and HCCA uses a non-contention-based channel access method using a polling mechanism. In addition, the HCF includes a medium access mechanism for improving QoS (Quality of Service) of the wireless LAN, and may transmit QoS data in both a Contention Period (CP) and a Contention Free Period (CFP).

Referring to FIG. 4, an operation based on a random backoff period will be described. When the occupied/busy medium changes to an idle state, several STAs may attempt to transmit data (or frames). As a method for minimizing collisions, each of STAs may respectively select a random backoff count and attempt transmission after waiting for a corresponding slot time. The random backoff count has a pseudo-random integer value and may be determined as one of values ranging from 0 to CW. Here, CW is a contention window parameter value. The CW parameter is given CWmin as an initial value, but may take a value twice as large in case of transmission failure (e.g., when an ACK for the transmitted frame is not received). When the CW parameter value reaches CWmax, data transmission may be attempted while maintaining the CWmax value until data transmission is successful, and when data transmission is successful, the CWmin value is reset. The values of CW, CWmin and CWmax are preferably set to 2ⁿ−1 (n=0, 1, 2, . . . ).

When the random backoff process starts, the STA continuously monitors the medium while counting down the backoff slots according to the determined backoff count value. When the medium is monitored for occupancy, it stops counting down and waits, and resumes the rest of the countdown when the medium becomes idle.

In the example of FIG. 4, when a packet to be transmitted arrives at the MAC of STA3, STA3 may transmit the frame immediately after confirming that the medium is idle as much as DIFS. The remaining STAs monitor and wait for the medium to be occupied/busy. In the meantime, data to be transmitted may also occur in each of STA1, STA2, and STA5, and each STA waits as long as DIFS when the medium is monitored as idle, and then may perform a countdown of the backoff slot according to the random backoff count value selected by each STA. Assume that STA2 selects the smallest backoff count value and STA1 selects the largest backoff count value. That is, the case where the remaining back-off time of STA5 is shorter than the remaining back-off time of STA1 at the time when STA2 completes the back-off count and starts frame transmission is exemplified. STA1 and STA5 temporarily stop counting down and wait while STA2 occupies the medium. When the occupation of STA2 ends and the medium becomes idle again, STA1 and STA5 wait for DIFS and resume the stopped backoff count. That is, frame transmission may be started after counting down the remaining backoff slots for the remaining backoff time. Since the remaining backoff time of STA5 is shorter than that of STA1, STA5 starts frame transmission. While STA2 occupies the medium, data to be transmitted may also occur in STA4. From the standpoint of STA4, when the medium becomes idle, STA4 may wait for DIFS, and then may perform a countdown according to the random backoff count value selected by the STA4 and start transmitting frames. The example of FIG. 4 shows a case where the remaining backoff time of STA5 coincides with the random backoff count value of STA4 by chance. In this case, a collision may occur between STA4 and STA5. When a collision occurs, both STA4 and STA5 do not receive an ACK, so data transmission fails. In this case, STA4 and STA5 may double the CW value, select a random backoff count value, and perform a countdown. STA1 waits while the medium is occupied due to transmission of STA4 and STA5, waits for DIFS when the medium becomes idle, and then starts frame transmission after the remaining backoff time has elapsed.

As in the example of FIG. 4, the data frame is a frame used for transmission of data forwarded to a higher layer, and may be transmitted after a backoff performed after DIFS elapses from when the medium becomes idle. Additionally, the management frame is a frame used for exchange of management information that is not forwarded to a higher layer, and is transmitted after a backoff performed after an IFS such as DIFS or Point Coordination Function IFS (PIFS). As a subtype frames of management frame, there are a Beacon, an association request/response, a re-association request/response, a probe request/response, an authentication request/response, etc. A control frame is a frame used to control access to a medium. As a subtype frames of control frame, there are Request-To-Send (RTS), Clear-To-Send (CTS), Acknowledgement (ACK), Power Save-Poll (PS-Poll), block ACK (BlockAck), block ACK request (BlockACKReq), null data packet announcement (NDP announcement), and trigger, etc. If the control frame is not a response frame of the previous frame, it is transmitted after backoff performed after DIFS elapses, and if it is a response frame of the previous frame, it is transmitted without performing backoff after short IFS (SIFS) elapses. The type and subtype of the frame may be identified by a type field and a subtype field in a frame control (FC) field.

A Quality of Service (QoS) STA may perform the backoff that is performed after an arbitration IFS (AIFS) for an access category (AC) to which the frame belongs, that is, AIFS[i] (where i is a value determined by AC), and then may transmit the frame. Here, the frame in which AIFS[i] can be used may be a data frame, a management frame, or a control frame other than a response frame.

FIG. 5 is a diagram for explaining a frame transmission operation based on CSMA/CA to which the present disclosure may be applied.

As described above, the CSMA/CA mechanism includes virtual carrier sensing in addition to physical carrier sensing in which a STA directly senses a medium. Virtual carrier sensing is intended to compensate for problems that may occur in medium access, such as a hidden node problem. For virtual carrier sensing, the MAC of the STA may use a Network Allocation Vector (NAV). The NAV is a value indicating, to other STAs, the remaining time until the medium is available for use by an STA currently using or having the right to use the medium. Therefore, the value set as NAV corresponds to a period in which the medium is scheduled to be used by the STA transmitting the frame, and the STA receiving the NAV value is prohibited from accessing the medium during the corresponding period. For example, the NAV may be configured based on the value of the “duration” field of the MAC header of the frame.

In the example of FIG. 5, it is assumed that a STA1 intends to transmit data to a STA2, and a STA3 is in a position capable of overhearing some or all of frames transmitted and received between the STA1 and the STA2.

In order to reduce the possibility of collision of transmissions of multiple STAs in CSMA/CA based frame transmission operation, a mechanism using RTS/CTS frames may be applied. In the example of FIG. 5, while transmission of the STA1 is being performed, as a result of carrier sensing of the STA3, it may be determined that the medium is in an idle state. That is, the STA1 may correspond to a hidden node to the STA3. Alternatively, in the example of FIG. 5, it may be determined that the carrier sensing result medium of the STA3 is in an idle state while transmission of the STA2 is being performed. That is, the STA2 may correspond to a hidden node to the STA3. Through the exchange of RTS/CTS frames before performing data transmission and reception between the STA1 and the STA2, a STA outside the transmission range of one of the STA1 or the STA2, or a STA outside the carrier sensing range for transmission from the STA1 or the STA3 may not attempt to occupy the channel during data transmission and reception between the STA1 and the STA2.

Specifically, the STA1 may determine whether a channel is being used through carrier sensing. In terms of physical carrier sensing, the STA1 may determine a channel occupation idle state based on an energy level or signal correlation detected in a channel. In addition, in terms of virtual carrier sensing, the STA1 may determine a channel occupancy state using a network allocation vector (NAV) timer.

The STA1 may transmit an RTS frame to the STA2 after performing a backoff when the channel is in an idle state during DIFS. When the STA2 receives the RTS frame, the STA2 may transmit a CTS frame as a response to the RTS frame to the STA1 after SIFS.

If the STA3 cannot overhear the CTS frame from the STA2 but can overhear the RTS frame from the STA1, the STA3 may set a NAV timer for a frame transmission period (e.g., SIFS+CTS frame+SIFS+data frame+SIFS+ACK frame) that is continuously transmitted thereafter, using the duration information included in the RTS frame. Alternatively, if the STA3 can overhear a CTS frame from the STA2 although the STA3 cannot overhear an RTS frame from the STA1, the STA3 may set a NAV timer for a frame transmission period (e.g., SIFS+data frame+SIFS+ACK frame) that is continuously transmitted thereafter, using the duration information included in the CTS frame. That is, if the STA3 can overhear one or more of the RTS or CTS frames from one or more of the STA1 or the STA2, the STA3 may set the NAV accordingly. When the STA3 receives a new frame before the NAV timer expires, the STA3 may update the NAV timer using duration information included in the new frame. The STA3 does not attempt channel access until the NAV timer expires.

When the STA1 receives the CTS frame from the STA2, the STA1 may transmit the data frame to the STA2 after SIFS from the time point when the reception of the CTS frame is completed. When the STA2 successfully receives the data frame, the STA2 may transmit an ACK frame as a response to the data frame to the STA1 after SIFS. The STA3 may determine whether the channel is being used through carrier sensing when the NAV timer expires. When the STA3 determines that the channel is not used by other terminals during DIFS after expiration of the NAV timer, the STA3 may attempt channel access after a contention window (CW) according to a random backoff has passed.

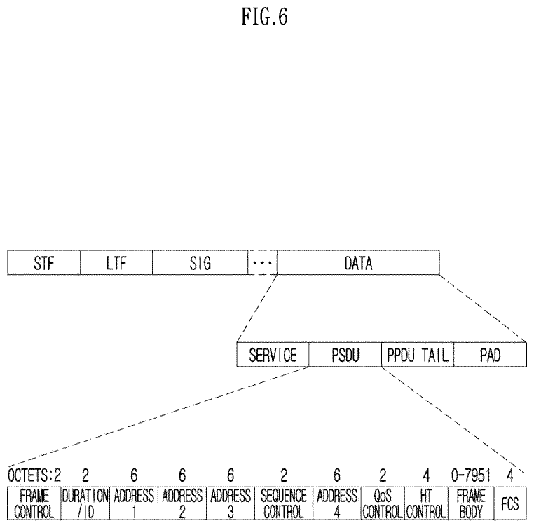

FIG. 6 is a diagram for explaining an example of a frame structure used in a WLAN system to which the present disclosure may be applied.

By means of an instruction or primitive (meaning a set of instructions or parameters) from the MAC layer, the PHY layer may prepare a MAC PDU (MPDU) to be transmitted. For example, when a command requesting transmission start of the PHY layer is received from the MAC layer, the PHY layer switches to the transmission mode and configures information (e.g., data) provided from the MAC layer in the form of a frame and transmits it. In addition, when the PHY layer detects a valid preamble of the received frame, the PHY layer monitors the header of the preamble and sends a command notifying the start of reception of the PHY layer to the MAC layer.

In this way, information transmission/reception in a wireless LAN system is performed in the form of a frame, and for this purpose, a PHY layer protocol data unit (PPDU) frame format is defined.

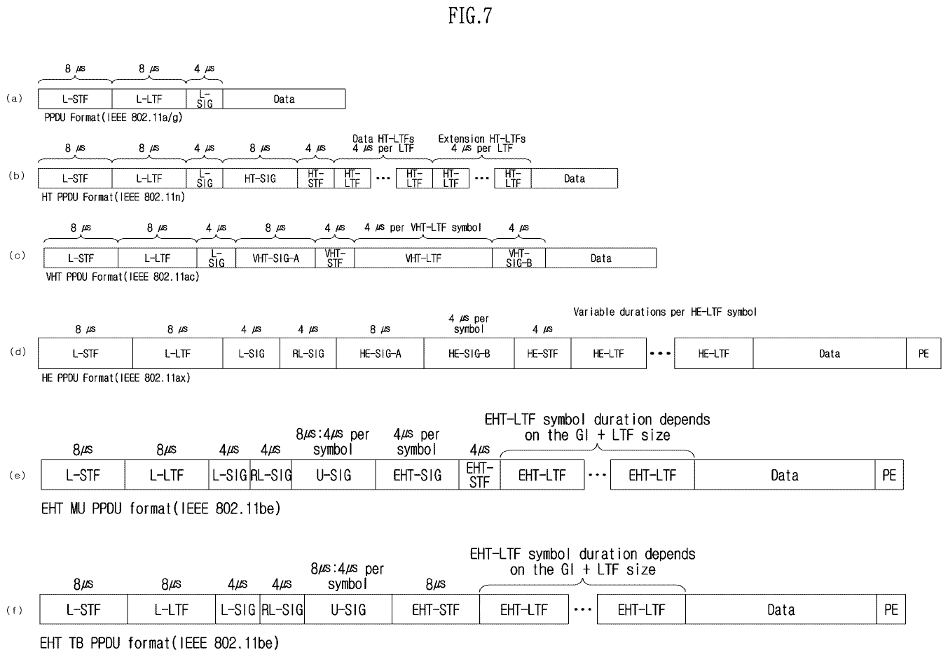

A basic PPDU may include a Short Training Field (STF), Long Training Field (LTF), SIGNAL (SIG) field, and Data (Data) field. The most basic PPDU format (e.g., non-HT (High Throughput) shown in FIG. 7) may consist of only the Legacy-STF (L-STF), Legacy-LTF (L-LTF), Legacy-SIG (L-SIG) fields, and data fields. Additionally, depending on the type of PPDU format (e.g., HT-mixed format PPDU, HT-greenfield format PPDU, VHT (Very High Throughput) PPDU, etc.), additional (or different types) of RL-SIG, U-SIG, non-legacy SIG fields, non-legacy STF, non-legacy LTF (i.e., xx-SIG, xx-STF, xx-LTF (e.g. xx is HT, VHT, HE, EHT, etc.)), etc. may be included between the L-SIG field and the data field.

The STF is a signal for signal detection, automatic gain control (AGC), diversity selection, precise time synchronization, and the like, and the LTF is a signal for channel estimation and frequency error estimation. The STF and LTF may be referred to as signals for synchronization and channel estimation of the OFDM physical layer.

The SIG field may include various information related to PPDU transmission and reception. For example, the L-SIG field consists of 24 bits and the L-SIG field may include 4-bit Rate field, 1-bit Reserved bit, 12-bit Length field, 1-bit Parity field, and 6-bit Tail field. The RATE field may include information about the modulation and coding rate of data. For example, the 12-bit Length field may include information about the length or time duration of the PPDU. For example, the value of the 12-bit Length field may be determined based on the type of PPDU. For example, for non-HT, HT, VHT, or EHT PPDU, the value of the Length field may be determined to be a multiple of 3. For example, for a HE PPDU, the value of the Length field may be determined as a multiple of 3+1 or a multiple of 3+2.

The data field may include a SERVICE field, a physical layer service data unit (PSDU), and a PPDU TAIL bit, and may also include padding bits if necessary. Some bits of the SERVICE field may be used for synchronization of the descrambler at the receiving end. The PSDU corresponds to the MAC PDU defined in the MAC layer, and may include data generated/used in the upper layer. The PPDU TAIL bit may be used to return the encoder to a 0 state. Padding bits may be used to adjust the length of a data field in a predetermined unit.

A MAC PDU is defined according to various MAC frame formats, and a basic MAC frame consists of a MAC header, a frame body, and a Frame Check Sequence (FCS). The MAC frame may consist of MAC PDUs and be transmitted/received through the PSDU of the data part of the PPDU frame format.

The MAC header includes a Frame Control field, a Duration/ID field, an Address field, and the like. The frame control field may include control information required for frame transmission/reception. The duration/ID field may be set to a time for transmitting a corresponding frame or the like. For details of the Sequence Control, QoS Control, and HT Control subfields of the MAC header, refer to the IEEE 802.11 standard document.

The null-data PPDU (NDP) format refers to a PPDU format that does not include a data field. In other words, NDP refers to a frame format that includes the PPDU preamble in a general PPDU format (i.e., L-STF, L-LTF, L-SIG fields, and additionally non-legacy SIG, non-legacy STF, non-legacy LTF if present) and does not include the remaining part (i.e., data field).

FIG. 7 is a diagram illustrating examples of PPDUs defined in the IEEE 802.11 standard to which the present disclosure may be applied.

In standards such as IEEE 802.11a/g/n/ac/ax, various types of PPDUs have been used. The basic PPDU format (IEEE 802.11a/g) includes L-LTF, L-STF, L-SIG and Data fields. The basic PPDU format may also be referred to as a non-HT PPDU format(as shown in FIG. 7(a)).

The HT PPDU format (IEEE 802.11n) additionally includes HT-SIG, HT-STF, and HT-LFT(s) fields to the basic PPDU format. The HT PPDU format shown in FIG. 7(b) may be referred to as an HT-mixed format. In addition, an HT-greenfield format PPDU may be defined, and this corresponds to a format consisting of HT-GF-STF, HT-LTF1, HT-SIG, one or more HT-LTF, and Data field, not including L-STF, L-LTF, and L-SIG (not shown).

An example of the VHT PPDU format (IEEE 802.11ac) additionally includes VHT SIG-A, VHT-STF, VHT-LTF, and VHT-SIG-B fields to the basic PPDU format(as shown in FIG. 7(c)).

An example of the HE PPDU format (IEEE 802.11ax) additionally includes Repeated L-SIG (RL-SIG), HE-SIG-A, HE-SIG-B, HE-STF, HE-LTF(s), Packet Extension (PE) field to the basic PPDU format(as shown in FIG. 7(d)). Some fields may be excluded or their length may vary according to detailed examples of the HE PPDU format. For example, the HE-SIG-B field is included in the HE PPDU format for multi-user (MU), and the HE-SIG-B is not included in the HE PPDU format for single user (SU). In addition, the HE trigger-based (TB) PPDU format does not include the HE-SIG-B, and the length of the HE-STF field may vary to 8 us. The Extended Range (HE ER) SU PPDU format does not include the HE-SIG-B field, and the length of the HE-SIG-A field may vary to 16 us. For example, RL-SIG may be configured the same as L-SIG. The receiving STA can know that the received PPDU is a HE PPDU or an EHT PPDU, which will be described later, based on the presence of the RL-SIG.

The EHT PPDU format may include the EHT MU (multi-user) in FIG. 7(e) and the EHT TB (trigger-based) PPDU in FIG. 7(f). The EHT PPDU format is similar to the HE PPDU format in that it includes RL-SIG followed by L-SIG, but may include U(universal)-SIG, EHT-SIG, EHT-STF, and EHT-LTF following RL-SIG.

The EHT MU PPDU in FIG. 7(e) corresponds to a PPDU carrying one or more data (or PSDU) for one or more users. That is, the EHT MU PPDU may be used for both SU transmission and MU transmission. For example, the EHT MU PPDU may correspond to a PPDU for one receiving STA or multiple receiving STAs.

The EHT TB PPDU in FIG. 7(f) omits the EHT-SIG compared to the EHT MU PPDU. An STA that receives a trigger (e.g., trigger frame or triggered response scheduling (TRS)) for UL MU transmission may perform UL transmission based on the EHT TB PPDU format.

L-STF, L-LTF, L-SIG, RL-SIG, U-SIG (Universal SIGNAL), EHT-SIG fields may be encoded and modulated so that even legacy STAs may attempt demodulation and decoding, and may be mapped based on a determined subcarrier frequency interval (e.g., 312.5 kHz). These may be referred to as pre-EHT modulated fields. Next, the EHT-STF, EHT-LTF, Data, PE fields may be encoded and modulated to be demodulated and decoded by an STA that successfully decodes the non-legacy SIG (e.g., U-SIG and/or EHT-SIG) and obtains the information included in the field, and may be mapped based on a determined subcarrier frequency interval (e.g., 78.125 kHz). These may be referred to as EHT modulated fields.

Similarly, in the HE PPDU format, the L-STF, L-LTF, L-SIG, RL-SIG, HE-SIG-A, and HE-SIG-B fields may be referred to as pre-HE modulation fields, and the HE-STF, HE-LTF, Data, and PE fields may be referred to as HE modulation fields. Additionally, in the VHT PPDU format, the L-STF, L-LTF, L-SIG, and VHT-SIG-A fields may be referred to as free VHT modulation fields, and VHT STF, VHT-LTF, VHT-SIG-B, and Data fields may be referred to as VHT modulation fields.

The U-SIG included in the EHT PPDU format of FIG. 7 may be configured based on, for example, two symbols (e.g., two consecutive OFDM symbols). Each symbol (e.g., OFDM symbol) for U-SIG may have a duration of 4 us, and U-SIG may have a total duration of 8 us. Each symbol of U-SIG may be used to transmit 26 bits of information. For example, each symbol of U-SIG can be transmitted and received based on 52 data tones and 4 pilot tones.

U-SIG may be constructed in units of 20 MHz. For example, if an 80 MHz PPDU is constructed, the U-SIG may be duplicated. That is, the same 4 U-SIGs may be included in the 80 MHz PPDU. PPDUs exceeding 80 MHz bandwidth may include different U-SIGs.

For example, A number of uncoded bits may be transmitted through U-SIG, the first symbol of U-SIG (e.g., U-SIG-1 symbol) may transmit the first X bits of information out of the total A bits of information, and the second symbol of U-SIG (e.g., U-SIG-2 symbol) may transmit the remaining Y bit information of the total A bit information. A-bit information (e.g., 52 uncoded bits) may include a CRC field (e.g., a 4-bit long field) and a tail field (e.g., a 6-bit long field). For example, the tail field may be used to terminate the trellis of the convolutional decoder and may be set to 0.

A bit information transmitted by U-SIG may be divided into version-independent bits and version-dependent bits. For example, U-SIG may be included in a new PPDU format not shown in FIG. 7 (e.g., UHR PPDU format), and in the format of the U-SIG field included in the EHT PPDU format and the format of the U-SIG field included in the UHR PPDU format, version-independent bits may be the same, and some or all of the version-dependent bits may be different.

For example, the size of the version-independent bits of U-SIG may be fixed or variable. Version-independent bits may be assigned only to the U-SIG-1 symbol, or to both the U-SIG-1 symbol and the U-SIG-2 symbol. Version-independent bits and version-dependent bits may be called various names, such as first control bit and second control bit.

For example, the version-independent bits of U-SIG may include a 3-bit physical layer version identifier (PHY version identifier), and this information may indicate the PHY version (e.g., EHT, UHR, etc.) of the transmitted/received PPDU. The version-independent bits of U-SIG may include a 1-bit UL/DL flag field. The first value of the 1-bit UL/DL flag field is related to UL communication, and the second value of the UL/DL flag field is related to DL communication. The version-independent bits of U-SIG may include information about the length of transmission opportunity (TXOP) and information about the BSS color ID.

For example, the version-dependent bits of U-SIG may include information directly or indirectly indicating the type of PPDU (e.g., SU PPDU, MU PPDU, TB PPDU, etc.).

Information necessary for PPDU transmission and reception may be included in U-SIG. For example, U-SIG may further include information about whether information on bandwidth, information on the MCS technique applied to the non-legacy SIG (e.g., EHT-SIG or UHR-SIG, etc.), information indicating whether the DCM (dual carrier modulation) technique (e.g., a technique to achieve an effect similar to frequency diversity by reusing the same signal on two subcarriers) is applied to the non-legacy SIG, information on the number of symbols used for the non-legacy SIG, non-legacy SIG is generated across the entire band.

Some of the information required for PPDU transmission and reception may be included in U-SIG and/or non-legacy SIG (e.g., EHT-SIG or UHR-SIG, etc.). For example, information on the type of non-legacy LTF/STF (e.g., EHT-LTF/EHT-STF or UHR-LTF/UHR-STF, etc.), information on the length of the non-legacy LTF and CP (cyclic prefix) length, information on GI (guard interval) applicable to non-legacy LTF, information on preamble puncturing applicable to PPDU, information on RU (resource unit) allocation, etc. may be included only in the U-SIG, only in the non-legacy SIG, or may be indicated by a combination of information included in the U-SIG and information included in the non-legacy SIG.

Preamble puncturing may mean transmission of a PPDU in which a signal does not exist in one or more frequency units among the bandwidth of the PPDU. For example, the size of the frequency unit (or resolution of preamble puncturing) may be defined as 20 MHz, 40 MHz, etc. For example, preamble puncturing may be applied to a PPDU bandwidth of a predetermined size or more.

In the example of FIG. 7, non-legacy SIGs such as HE-SIG-B and EHT-SIG may include control information for the receiving STA. A non-legacy SIG may be transmitted over at least one symbol, and one symbol may have a length of 4 us. Information about the number of symbols used for the EHT-SIG may be included in previous SIGs (e.g., HE-SIG-A, U-SIG, etc.).

Non-legacy SIGs such as HE-SIG-B and EHT-SIG may include common fields and user-specific fields. Common fields and user-specific fields may be coded separately.

In some cases, common fields may be omitted. For example, in a compression mode where non-OFDMA (orthogonal frequency multiple access) is applied, the common field may be omitted, and multiple STAs may receive a PPDU (e.g., a data field of the PPDU) through the same frequency band. In a non-compressed mode where OFDMA is applied, multiple users may receive a PPDU (e.g., a data field of the PPDU) through different frequency bands.

The number of user-specific fields may be determined based on the number of users. One user block field may include up to two user fields. Each user field may be associated with a MU-MIMO allocation or may be associated with a non-MU-MIMO allocation.

The common field may include a CRC bit and a Tail bit, and the length of the CRC bit may be determined to be 4 bits, and the length of the Tail bit may be determined to be 6 bits and set to 000000. The common field may include RU allocation information. RU allocation information may include information about the location of the RU to which multiple users (i.e., multiple receiving STAs) are assigned.

RU may include multiple subcarriers (or tones). RU may be used when transmitting signals to multiple STAs based on OFDMA technique. Additionally, RU may be defined even when transmitting a signal to one STA. Resources may be allocated in RU units for non-legacy STF, non-legacy LTF, and Data fields.

An RU of applicable size may be defined according to the PPDU bandwidth. RU may be defined identically or differently for the applied PPDU format (e.g., HE PPDU, EHT PPDU, UHR PPDU, etc.). For example, in the case of 80 MHz PPDU, the RU placement of HE PPDU and EHT PPDU may be different. applicable RU size, number of RU, and RU location for each PPDU bandwidth, DC (direct current) subcarrier location and number, null subcarrier location and number, guard subcarrier location and number, etc. may be referred to as a tone-plan. For example, a tone-plan for high bandwidth may be defined in the form of multiple iterations of a low-bandwidth tone-plan.

RUs of various sizes may be defined as 26-tone RU, 52-tone RU, 106-tone RU, 242-tone RU, 484-tone RU, 996-tone RU, 2×996-tone RU, 3×996-tone RU, etc. MRU (multiple RU) is distinguished from a plurality of individual RUs and corresponds to a group of subcarriers composed of a plurality of RUs. For example, one MRU may be defined as 52+26-tone, 106+26-tone, 484+242-tone, 996+484-tone, 996+484+242-tone, 2×996+484-tone, 3×996-tone, or 3×996+484-tone. Additionally, a plurality of RUs constituting one MRU may or may not be continuous in the frequency domain.

The specific size of the RU may be reduced or expanded. Accordingly, the specific size of each RU (i.e., the number of corresponding tones) in the present disclosure is not limiting and is illustrative. Additionally, in the present disclosure, within a predetermined bandwidth (e.g., 20, 40, 80, 160, 320 MHz, . . . ), the number of RUs may vary depending on the RU size.

The names of each field in the PPDU formats of FIG. 7 are exemplary, and the scope of the present disclosure is not limited by the names. In addition, examples of the present disclosure may be applied to the PPDU format illustrated in FIG. 7 as well as to a new PPDU format in which some fields are excluded and/or some fields are added based on the PPDU formats of FIG. 7.

### Method for Transmitting and Receiving Relay Frames Controlled by AP

In next-generation wireless LAN systems (e.g., Next Wi-Fi, IEEE beyond 802.11be, etc.), various technologies are being considered to support high throughput, low latency, extended range, etc. in order to support ultra-high reliability (UHR) in signal transmission to STA.

The proposed method in the present disclosure relates to a method of transmitting a signal to an STA using a relay method controlled by an AP to expand coverage/range for reliable transmission to various IoT devices as well as outdoors. Specifically, a data construction for transmitting a signal using a relay STA (e.g., PPDU, A-MPDU) and a signaling method for the relay are proposed.

In the case of the method proposed in the present disclosure, considering the ease of implementation for the relay and the complexity of the operation, it may be based on a relay transmission method controlled by the AP.

For clarity of explanation, in the embodiments of the present disclosure below, a relay STA controlled by an AP is referred to as an AP controlled Relay STA (ACRS).

For example, ACRS performs relay transmission for data received from an AP within a BSS, and at this time, all control of ACRS for relay may be performed by the corresponding AP. That is, ACRS may transmit a signal (e.g., a data frame) received from an AP to an end-user/STA based on information received from the AP.

Here, ACRS may correspond to an independent relay device that only performs relay transmission, or may correspond to a non-AP STA that supports relay.

First, a method for performing negotiation with AP and relay is specifically described.

An ACRS relaying data to an STA under the control of an AP may use a (re)association request/response frame or a probe request/response frame to indicate that it is a relay STA or an STA supporting relay transmission. At this time, the frame may be configured to include a relay support field, relay transmission capabilities, and/or a relay operation element.

For example, the AP may identify a relay STA (i.e., ACRS) through negotiation using the relay support field, relay transmission capability, and/or relay operation element, and may assign an ID to the identified relay STA(s). As an example, the ID of the relay STA (e.g., RSID) may be configured as a specific ID of the STA ID.

In order to relay a signal using ACRS operating as described above, the AP may indicate related information through a specific frame (e.g., a beacon frame, etc.) to perform transmission through a relay within the BSS or to instruct relay transmission support. That is, relay-related negotiation may be performed based on transmission and reception of the specific frame.

For example, an AP may transmit a beacon frame including relay transmission capabilities/element related information and/or relay transmission support related information to notify the BSS of ACRS support or relay transmission performance.

Specifically, the relay transmission capability/element related information relates to information indicating that relay transmission is supported, and the capability information may be configured to include one or more parameters for relay transmission as follows.

For example, a subfield related to ACRS ID or IDs may be included. Here, the ACRS ID or IDs may correspond to an AID or RSID allocated to the relay STA. For example, a relay operation subfield may be included. Here, the subfield may be configured with 1 bit, and may be defined such that a value of 1 indicates relay transmission and a value of 0 indicates no relay transmission. For example, a subfield related to the maximum number of STAs may be included. Here, the parameter may be configured with 2 bits or 3 bits, and may indicate the maximum number of STAs that the relay STA may support through the relay mode when performing relay transmission. For example, a subfield related to a relay mode may be included. Relaying performed under the control of the AP may be performed in various modes, and the subfield may be configured with 2 bits or 3 bits for indicating the relay mode. For example, a subfield related to whether 4 addresses are supported may be included. This subfield may indicate information for whether the four address fields that included in the MAC frame are supported.

Specifically, information related to relay transmission support consists of 1 bit and may indicate whether relay transmission is supported within the corresponding BSS.

Next, the format of the relay frame and the relay transmission method are specifically described.

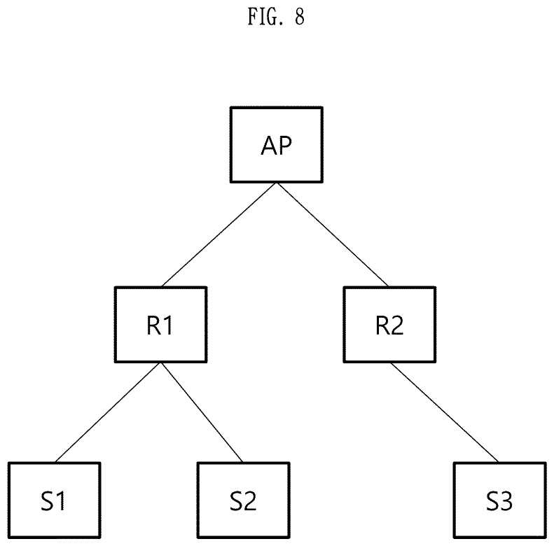

As mentioned above, the relay STA configured to ACRS through negotiation with the AP may perform relay transmission using the architecture configured as shown in FIG. 8 when performing relay operation within the BSS.

FIG. 8 illustrates a relay transmission structure according to an embodiment of the present disclosure.

Referring to FIG. 8, R1 and R2 represent ACRSs described above in the present disclosure, and S1, S2, and S3 represent non-AP STAs that transmit and receive signals with the AP through the relay STA.

The relay transmission illustrated in FIG. 8 may correspond to a 1-hop based relay transmission. In this case, the relay transmission flow may be composed of AP-ACRS-non-AP STA. For example, in a next-generation wireless LAN system, relay transmission may be restricted to 1-hop.

Data for relay transmission as described above may be defined/configured in the manner described below. Specifically, data transmitted via the relay method can be transmitted using the format of A-MPDU or A-MSDU, and the corresponding frame format may be configured as follows.

For example, in order to indicate that the frame corresponds to a relay transmission frame, a data frame transmitted via a relay method may indicate that it corresponds to a relay data frame using the Type and Subtype subfields of the MAC header.

As a detailed example, the Type and Subtype subfields may be set as follows to indicate that it is a relay transmission frame.

First, the Type field is set to 10, which may indicate that it corresponds to a data frame.

Next, when the Type field is set to 10 to indicate a data frame, the Subtype subfield may be indicated using a reserved value.

For example, corresponding to a relay data frame may be indicated using one of the values 0001 to 0011, and 0101 to 0111. As an example, the value 0001 may be defined to indicate corresponding to a relay data frame. As another example, for indicating whether the relay data frame is individual or group, 0001 or 0101 may be defined to indicate individual relay transmission, and 0010 or 0110 may be defined to indicate group relay transmission. The setting of the values in the above examples is only an example, and the indication may also be performed using other reserved values of the Subtype subfield.

Additionally, for a frame in which the Type and Subtype subfields are set to indicate a relay frame as described above, the [To DS subfield and From DS subfield] and address fields (e.g., AD1, AD2, AD3, and AD4) of the frame control field included in the MAC header may be set as follows.

First, a relay frame for indicating individual transmission is described. Here, individual transmission may mean a case where data transmitted by an AP to a relay STA corresponds to data transmitted to a non-AP STA.

At this time, the To DS subfield of the frame control field of the MAC header may be set to a value of 1, and the From DS subfield may be set to a value of 1. In this regard, a frame is generated based on four addresses, and each address may be set as in the following example for DL transmission and UL transmission.

For example, in case of DL transmission, AD1 (i.e., address 1) may be set to the ID/RA of the ACRS that receives the frame transmitted by the AP. That is, AD1 may be set to the AID or RSID of the ACRS.

Additionally, AD2 (i.e., address 2) is configured as a Transmitter Address (TA) that transmits the frame and may be set to the address of an AP that transmits the relay frame. That is, AD2 may be set to the ID of the AP or the BSS ID.

Additionally, AD3 (i.e., address 3) may be set as ID information for the end-STA to which the data/frame transmitted by the AP to the ACRS must ultimately reach. That is, AD3 may indicate the Destination Address (DA) in the MSDU included in the corresponding relay frame.

Additionally, AD4 (i.e., address 4) is the ID information of the STA that initiated the data/frame transmitted by the AP to the ACRS, and may be set to the BSS ID or AP address information of the AP. That is, AD4 may indicate the Source Address (SA) in the MSDU included in the frame transmitted by the AP.

For another example, in case of UL transmission, AD1 may be configured with an Receiver Address (RA) that receives the frame, and may be set to the ID or BSS ID of the AP that receives the frame transmitted by the relay STA.

Additionally, AD2 (i.e., address 2) may be configured as a TA transmitting a frame and may be set to the address of an ACRS transmitting a relay frame. That is, AD2 may be set to an ID of a relay STA or an ACRS ID.

Additionally, AD3 (i.e., address 3) may be configured with ID information for the AP to which the data/frame transmitted to ACRS should ultimately reach. That is, AD3 may indicate the DA within the MSDU included in the corresponding relay frame.

Additionally, AD4 (i.e., address 4) is the ID information of the non-AP STA that initiated the data/frame transmitted by ACRS, and may be set to the ID or STA-ID of the non-AP STA. That is, AD4 may indicate the SA within the MSDU included in the frame transmitted by ACRS.

Additionally or alternatively, with respect to the above-mentioned individual transmission, a DL frame for an individual STA may be used/applied when transmitting to grouped STAs. At this time, among the above-mentioned addresses, AD3 is set to a group address (e.g., GID), and the AD3 may indicate a DA within an MSDU included in the frame. Through this, a relay frame for multiple STAs may be configured.

Next, a relay frame for indicating grouped transmission is described. Here, grouped transmission may mean a case where an AP transmits a signal/data to multiple STAs or grouped STAs through a relay method.

At this time, the To DS subfield of the frame control field of the MAC header may be set to a value of 0, and the From DS subfield may be set to a value of 1. In this regard, a frame may be generated based on three addresses, and each address may be set as in the following example.

For example, AD1 corresponds to RA and may be set to the ID of ACRS that receives the frame transmitted by AP. That is, AD1 may be set to the AID or RSID of ACRS. Additionally, AD2 may correspond to TA and may be set to the ID or BSS ID information of AP that initiates and transmits the frame/data to be relayed. Additionally, AD3 may correspond to group ID and may be set to the GID or specific ID for multiple STAs or grouped STAs that ultimately receive the frame/data transmitted by AP through ACRS.

As a concrete example, when considering DL relay transmission, AD1 may be set to the relay ID or ACRS ID, AD2 may be set to the AP's ID or BSS ID, and AD3 may be set to the group ID (i.e., GID).

Additionally or alternatively, a frame transmitted to multiple STAs using a relay method may also be used/applied to individual transmission. At this time, in the above-described address setting, AD3 may be set and used as ID information of a non-AP STA to which the signal/data ultimately reaches via the relay.

In the following disclosure, the structure of frames transmitted and received via the aforementioned relay method is specifically described through various examples.

Specifically, the relayed frame may be constructed using A-MSDU, A-MPDU, or A-MSDU and A-MPDU.

First, the frame construction method in the case of transmitting a signal/data using A-MSDU is explained.

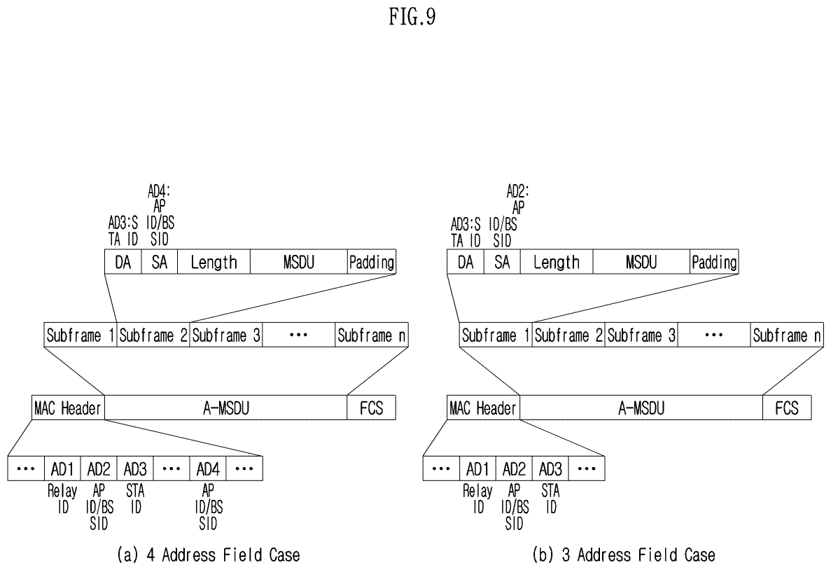

Regarding the frame construction for transmission from AP to relay, in the case of DL transmission when transmitting to an individual STA, the frame may include 4 or 3 address fields as shown in FIG. 9.

FIG. 9 illustrates an A-MSDU-based frame format for relay transmission to individual non-AP STAs according to an embodiment of the present disclosure.

Referring to FIG. 9, a frame transmitted and received via a relay method may include a MAC header, an A-MSDU composed of one or more subframes, and an FCS.

In the case of (a) of FIG. 9, that is, when four address fields are included, the MAC header includes an AD1 field, an AD2 field, an AD3 field, and an AD4 field. At this time, the AD1 field may be set to relay ID information, the AD2 field may be set to AP ID or BSS ID information, the AD3 field may be set to STA ID, that is, ID information of the STA that is the target of relay transmission, and the AD4 field may be set to AP ID or BSS ID information.

In this regard, in each subframe belonging to the A-MSDU, the DA field may be set to the ID of the STA corresponding to the value of the AD3 field, and the SA field may be set to the ID or BSS ID of the AP corresponding to the value of the AD4 field.

In the case of (b) of FIG. 9, that is, when three address fields are included, the MAC header includes an AD1 field, an AD2 field, and an AD3 field. At this time, the AD1 field may be set to relay ID information, the AD2 field may be set to AP ID or BSS ID information, and the AD3 field may be set to STA ID, that is, ID information of the STA that is the target of relay transmission.

In this regard, in each subframe belonging to the A-MSDU, the DA field may be set to the ID of the STA corresponding to the value of the AD3 subfield, and the SA field may be set to the ID or BSS ID of the AP corresponding to the value of the AD2 subfield.

Additionally, the structure described above (e.g., the frame structure of FIG. 9) may be used for the frame configuration for transmission from the relay to the AP. In this case, the information of the DA field and the information of the SA field may set oppositely, and the address field may be set identically to the structure described above.

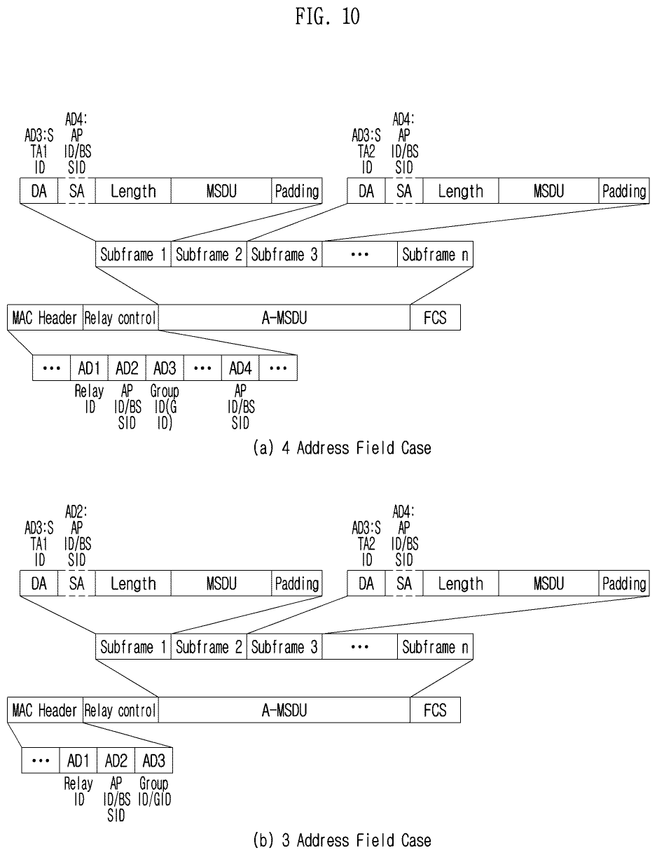

When considering transmission to multiple STAs or a group of STAs, a frame structure such as that in FIG. 10 may be configured.

FIG. 10 illustrates an A-MSDU-based frame format for relay transmission for multiple non-AP STAs or grouped non-AP STAs according to an embodiment of the present disclosure.

Referring to FIG. 10, a frame transmitted and received via a relay method may include a MAC header, a relay control field, an A-MSDU composed of one or more subframes, and an FCS.

In the case of (a) of FIG. 10, that is, when four address fields are included, the MAC header includes an AD1 field, an AD2 field, an AD3 field, and an AD4 field. At this time, the AD1 field may be set to relay ID information, the AD2 field may be set to AP ID or BSS ID information, the AD3 field may be set to group ID (i.e., GID) information, and the AD4 field may be set to AP ID or BSS ID information.

In the case of (b) of FIG. 10, that is, when three address fields are included, the MAC header includes an AD1 field, an AD2 field, and an AD3 field. At this time, the AD1 field may be set to relay ID information, the AD2 field may be set to AP ID or BSS ID information, and the AD3 field may be set to group ID (i.e., GID) information.

When using A-MSDU for relay transmission to multiple STAs, A-MSDU is encrypted by considering it as a single frame. Therefore, the relay STA, i.e. ACRS, may determine that it may not recognize the information about the STA(s) to which the data included in A_MSDU is transmitted, i.e. DA, through AD.

Therefore, as illustrated in (a) and (b) of FIG. 10, in the case of A-MSDU, control information for the relay may be additionally configured in the front part of the encrypted A-MSDU or frame body to inform the relay STA of information for the STA(s) to which data is transmitted.

Specifically, the relay control field consists of information for STA(s) receiving data using A-MSDU, and may consist of a combination of the following information.
Number of STAs for relay: This subfield indicates the number of non-AP STAs or STA-IDs that receive signals through the relay.
STA ID or DA field(s): This subfield indicates ID information for STA(s) receiving signals/data through the relay. At this time, there may be as many STA ID fields as there are STAs for the relay.
Total number of subframes: This subfield indicates the total number of subframes that included in the A-MSDU.
Number of subframes allocated to STA: This subfield indicates the number of subframes transmitted to STA in the order of the STA IDs mentioned above.
SA present: This subfield indicates whether the SA field exists.

In relation to this method, data for one STA may be composed of one or more subframes. In this case, the DA field and SA field of the A-MSDU subframes allocated to one STA may be set identically.

Additionally, the DA field of the A-MSDU subframe constituting the subframe allocated to each STA may be set to each STA ID, and the SA field may be set to an AP ID or BSS ID. In this regard, when transmitting to multiple STAs or relay transmitting to a group STA, since the data transmitted through the relay is transmitted by the initiation of the initial AP, the SA field may be omitted in the above-described structure (e.g., the frame structure of FIG. 10).

Additionally, the structure described above (e.g., the frame structure of FIG. 10) may be used even in the case of frame configuration for transmission from a relay to an AP. In this case, the information of the DA field and the information of the SA field may be set oppositely, and the address field may be set identically to the structure described above.

Next, the frame construction method in the case of transmitting a signal/data using A-MPDU is described.

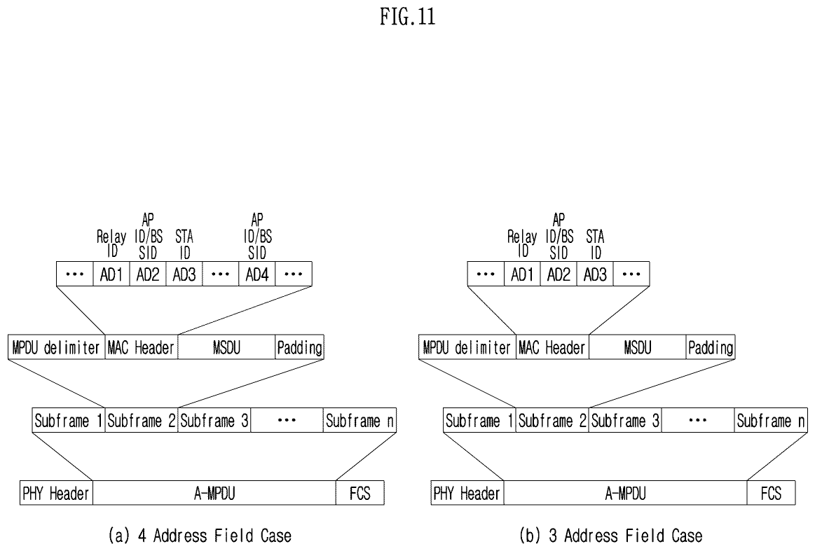

Regarding the frame construction for transmission from AP to relay, when transmitting to an individual STA, the frame may be configured as an A-MPDU constructed including 4 or 3 address fields as shown in FIG. 11.

FIG. 11 illustrates an A-MPDU based frame format for relay transmission to individual non-AP STAs according to an embodiment of the present disclosure.

Referring to FIG. 11, a frame transmitted and received via a relay mode may include a PHY header, an A-MPDU composed of one or more subframes, and an FCS. Here, the A-MPDU may be constructed to include one or more subframes, and each subframe may be constructed to include an MPDU delimiter, a MAC header, an MSDU, and padding.

In the case of (a) of FIG. 11, that is, when four address fields are included, the MAC header includes an AD1 field, an AD2 field, an AD3 field, and an AD4 field. At this time, the AD1 field may be set to relay ID information, the AD2 field may be set to AP ID or BSS ID information, the AD3 field may be set to STA ID, that is, ID information of the STA that is the target of relay transmission, and the AD4 field may be set to AP ID or BSS ID information.

In the case of (b) of FIG. 11, that is, when three address fields are included, the MAC header includes an AD1 field, an AD2 field, and an AD3 field. At this time, the AD1 field may be set to relay ID information, the AD2 field may be set to AP ID or BSS ID information, and the AD3 field may be set to STA ID, that is, ID information of the STA that is the target of relay transmission.

In contrast to the case where a signal is transmitted to a non-AP STA via a relay STA using a frame of the aforementioned structure, in the case where a signal is transmitted to an AP, the AD configuration (i.e., a configuration of the address field) may be set as in the description of the UL transmission described above in the present disclosure.

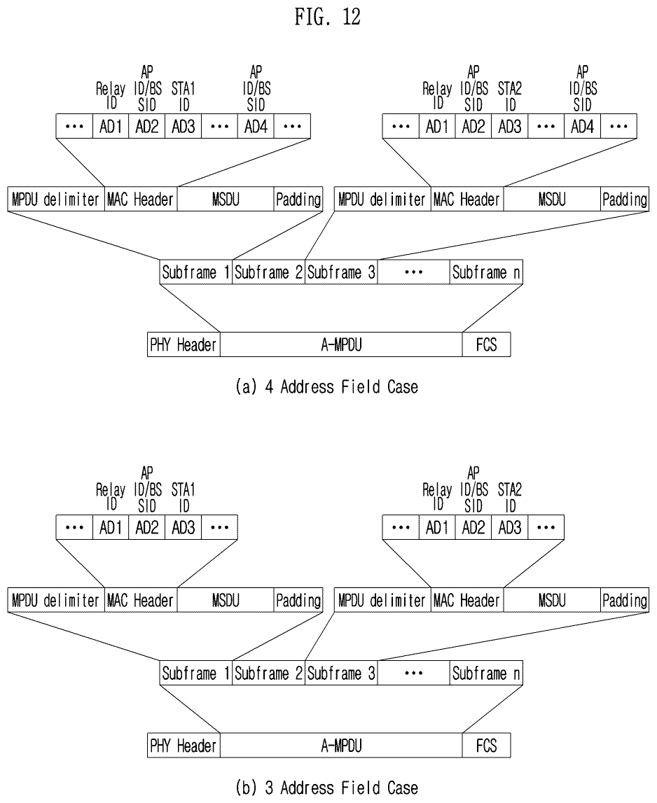

In the case where transmission to multiple STAs or group STAs is considered, a frame structure such as that of FIG. 12 may be constructed.

FIG. 12 illustrates an A-MPDU based frame format for relay transmission to multiple non-AP STAs or grouped non-AP STAs according to an embodiment of the present disclosure.

Referring to FIG. 12, a frame transmitted and received via a relay mode may include a PHY header, an A-MPDU composed of one or more subframes, and an FCS. Here, the A-MPDU may be constructed to include one or more subframes, and each subframe may be constructed to include an MPDU delimiter, a MAC header, an MSDU, and padding.

In the case of (a) of FIG. 12, that is, when four address fields are included, the MAC header includes an AD1 field, an AD2 field, an AD3 field, and an AD4 field. At this time, the AD1 field may be set to relay ID information, the AD2 field may be set to AP ID or BSS ID information, the AD3 field may be set to STA ID, that is, ID information of an STA that is a target of relay transmission, and the AD4 field may be set to AP ID or BSS ID information. Here, the AD3 field may be set to ID information of an STA that is a transmission target of the corresponding subframe (e.g., STA1 ID, STA2 ID).

In the case of (b) of FIG. 12, that is, when three address fields are included, the MAC header includes an AD1 field, an AD2 field, and an AD3 field. At this time, the AD1 field may be set to relay ID information, the AD2 field may be set to AP ID or BSS ID information, and the AD3 field may be set to STA ID, that is, ID information of an STA that is a target of relay transmission. Here, the AD3 field may be set to ID information of an STA that is a transmission target of the corresponding subframe (e.g., STA1 ID, STA2 ID).

When constructing an A-MPDU subframe as described above, the DA field and SA field of the MSDU included in each A-MPDU subframe may be set to the values of the AD3 field and the AD4 field of each A-MPDU, respectively.

Additionally or alternatively, unlike the above, AD3 may be set to a group ID (i.e., GID). In this case, the DA field and the SA field of the MSDU included in each A-MPDU subframe may be set to the values of the STA ID and AD4 field, respectively, to which the corresponding frame of each A-MPDU is finally transmitted, i.e., to be received.

As described above, in the case of performing relay transmission using A-MPDU, regardless of individual transmission or group transmission, in order to use a common A-MPDU frame, a specific bit included in an A-MPDU subframe may be defined to indicate individual transmission or group transmission. For example, a reserved bit (e.g., b1) included in an MPDU delimiter for each A-MPDU subframe may be used to indicate whether the A-MPDU transmitted by the AP to the relay STA (e.g., ACRS) is for individual transmission or transmission to multiple STAs. As a specific example, a value of 0 of the bit may be defined to indicate individual transmission, and a value of 1 of the bit may be defined to indicate transmission to multiple STAs or group STAs.

Additionally or alternatively, a relay STA (i.e., ACRS) that receives a signal from an AP or STA(s) using a frame of the aforementioned structure may transmit the received frame to a final destination STA. At this time, in the case of DL transmission, the relay STA (i.e., ACRS) may transmit the frame by setting the TA and/or SA of the transmitted frame to the ID or BSS ID information of the AP.

At this time, the relay STA may use the same SSID as the AP when transmitting a signal to the end STA or user. The TA and/or SA of the MPDU transmitted by the relay to the non-AP STA may be set to the ID of the AP, and through this, the non-AP STA may be transparently recognized when transmitting the relay.

Additionally, in case of UL transmission, for clear transmission as described above, the TA and/or SA of the frame that the relay STA transmits to the AP may be set to the ID of the non-AP STA that transmits the corresponding signal. As another example, since the AP already recognizes the relay transmission within the BSS, the TA of the frame that the relay STA transmits to the UL (i.e., the frame that is transmitted to the AP) may be set to the ID of the relay STA, and the SA may be set to the ID of the non-AP STA that transmitted the corresponding signal.

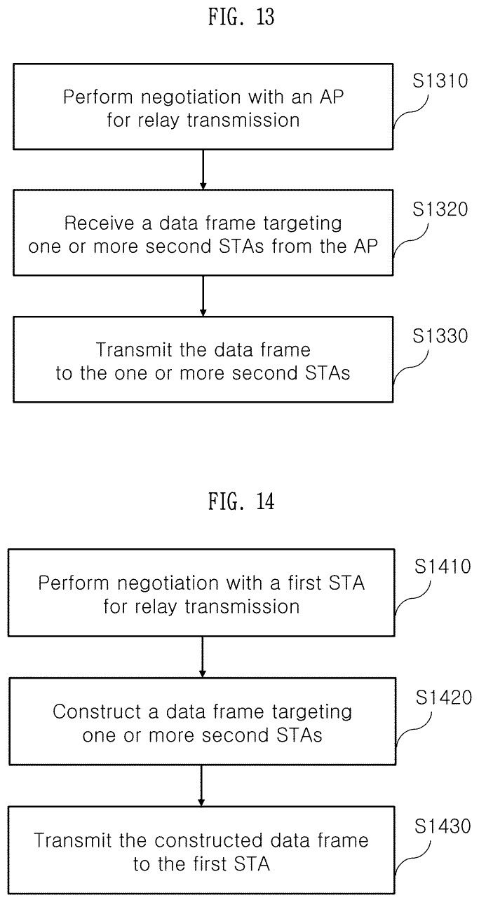

Hereinafter, the operation of the STA according to the embodiment of the present disclosure described above will be described with reference to FIGS. 13 and 14.

That is, the examples of FIGS. 13 and 14 may correspond to some of the various examples of the present disclosure. For example, in FIGS. 13 and 14, the first STA may correspond to a relay STA (e.g., ACRS), and the second STA may correspond to a target STA (i.e., end-STA) of the relay transmission.

FIG. 13 illustrates an operation flow chart by a first STA according to an embodiment of the present disclosure.

Referring to FIG. 13, the first STA may correspond to a non-AP STA controlled by an AP for relay transmission.

The first STA may perform negotiation with the AP for relay transmission (S1310).

For example, an operation for negotiating support for relay transmission may include an operation for receiving capability information for the relay transmission. Here, the capability information may include one or more of identification information of the relay STA, information for whether the relay is operating, the maximum number of relay-supporting STAs, information for the relay mode, or information for whether four address fields in the MAC header are supported.

The first STA may receive a data frame targeting one or more second STAs from the AP (S1320).

Thereafter, the first STA may transmit the data frame received from the AP to one or more second STAs (S1330).

In this regard, a medium access control (MAC) header in the data frame may include information indicating that the corresponding data frame is transmitted and received through a relay.

For example, the information may be indicated by a combination of a Type value and a Subtype value in the Type and Subtype subfield in the MAC header. Here, the Type and Subtype subfield may be included in a Frame Control Field included in the MAC header in a data frame. For example, a Type value consisting of 2 bits may be set to 00 to indicate a management frame, set to 01 to indicate a control frame, and set to 11 to indicate a data frame. Additionally, the Subtype value consists of 4 bits and may be defined to indicate a more detailed type for a type determined by the Type value.

As a specific example, to indicate that the corresponding data frame corresponds to a relayed frame, the Type value may be set to 10 and the Subtype value may be set to one of 0001, 0010, 0011, 0101, 0110, or 0111. That is, a Subtype value that is not defined/reserved in the existing specification may be utilized to indicate a relay frame. Additionally or alternatively, the Subtype value may be set differently when the data frame targets one second STA (e.g., individual transmission) and when it targets multiple second STAs (e.g., group transmission).

Additionally, at least one of the multiple address fields included in the aforementioned MAC header may be set as identification information for the first STA.

In this regard, the To DS subfield and the From DS subfield included in the frame control field in the corresponding MAC header may be utilized. For example, both the To DS subfield and the From DS subfield being set to 0 (i.e., [0, 0]) may indicate transmission and reception between STAs within an IBSS or a single BSS, the To DS subfield and the From DS subfield being set to [0, 1] may indicate a data frame transmitted from an AP to a wireless STA (i.e., DL transmission and reception), the To DS subfield and the From DS subfield being set to [1, 0] may indicate a data frame transmitted from a wireless STA to an AP (i.e., UL transmission and reception), and the To DS subfield and the From DS subfield being set to [1, 1] may indicate transmission and reception through a wireless bridge.

A detailed example of configuring the address field value for the relayed data frame proposed in the present disclosure is as follows.

For example, when the value of the To DS subfield in the MAC header is set to 1 and the value of the From DS subfield is set to 1, the aforementioned multiple address fields may include a first address field, a second address field, a third address field, and a fourth address field. At this time, the first address field may be set to identification information for the first STA, the second address field may be set to identification information for the AP, the third address field may be set to identification information for a single second STA or identification information for a group to which multiple second STAs belong, and the fourth address field may be set to identification information for the AP.

For example, if the value of the To DS subfield in the MAC header is set to 0 and the value of the From DS subfield is set to 1, the aforementioned multiple address fields may include a first address field, a second address field, and a third address field. At this time, the first address field may be set to identification information for the first STA, the second address field may be set to identification information for the AP, and the third address field may be set to identification information for a group to which multiple second STAs belong or identification information for a single second STA.

Additionally or alternatively, the aforementioned data frame may be constructed based on an aggregated-MAC service data unit (A-MSDU) constructed with one or more subframes.

For example, if the data frame targets multiple second STAs, the data frame may further include a specific field including information for the multiple second STAs (e.g., a relay control field) before the A-MSDU. Here, the information for the multiple second STAs may include one or more of the number of second STAs, identification information for each second STA belonging to the multiple second STAs, the number of subframes constituting the A-MSDU, the number of subframes allocated to each second STA belonging to the multiple second STAs, or information indicating the presence or absence of a source address (SA) field.

In this regard, the destination address (DA) field of each subframe belonging to the A-MSDU may be set to identification information for the second STA targeted by the subframe, and the source address (SA) field may be set to identification information for the AP.

Additionally or alternatively, the aforementioned data frame may be constructed based on an aggregated-MAC protocol data unit (A-MPDU) constructed with one or more subframes, and each subframe belonging to the A-MPDU may include the aforementioned MAC header and a MAC service data unit (MSDU).

For example, the destination address (DA) field of the MSDU may be set to identification information for a second STA targeted by the subframe or identification information for a group to which multiple second STAs belong, and the source address (SA) field may be set to identification information for the AP. Additionally, each subframe belonging to the A-MPDU may further include 1-bit information indicating whether the A-MPDU targets a single second STA or multiple second STAs (e.g., some bits of the MPDU delimiter).

The method performed by the first STA described in the example of FIG. 13 may be performed by the first device (100) of FIG. 1. For example, one or more processors (102) of the first device (100) of FIG. 1 may be configured to perform negotiation with an AP for relay transmission via one or more transceivers (106), receive a data frame targeting one or more second STAs, and transmit the received data frame to one or more second STAs. Furthermore, one or more memories (104) of the first device (100) may store commands for performing the method described in the example of FIG. 13 or the examples described above when executed by one or more processors (102).

FIG. 14 illustrates an operation flow chart by an AP according to an embodiment of the present disclosure.

Referring to FIG. 14, the first STA may correspond to a non-AP STA controlled by the AP for relay transmission.

The AP may perform negotiation with the first STA for relay transmission (S1410).

For negotiated relay transmission, the AP may configure a data frame targeting one or more second STAs (S1420), and transmit the configured data frame to the first STA for relay-based transmission (S1430).

In this regard, a medium access control (MAC) header within a data frame may include information indicating that the data frame is transmitted and received via a relay. Additionally, at least one of a plurality of address fields included in the aforementioned MAC header may be set as identification information for the first STA.

The specific description of the instruction information on whether to transmit the relay in FIG. 14, the setting of values for the address field, the configuration of the data frame structure, etc. are the same as those described in the example of FIG. 13, so redundant description is omitted.

The method performed by the AP described in the example of FIG. 14 may be performed by the second device (200) of FIG. 1. For example, one or more processors (202) of the second device (200) of FIG. 1 may be configured to perform negotiation with the first STA for relay transmission, configure a data frame targeting one or more second STAs in relation to the relay transmission, and transmit the data frame to the first STA through one or more transceivers (206).

For example, in an encoding operation for configuring a data frame, one or more processors (202) of the second device (200) of FIG. 1 may include information indicating that the data frame is transmitted and received through a relay in a medium access control (MAC) header, and set at least one of a plurality of address fields included in the MAC header as identification information for the first STA.

Furthermore, one or more memories (204) of the second device (200) may store instructions for performing the method described in the example of FIG. 14 or the examples described above when executed by one or more processors (202).

In the existing wireless LAN system, although general relay operation is defined, a relay method in which a non-AP STA controlled by an AP is made a relay STA is not stipulated. Considering this, the proposed method in the present disclosure is about a relay method in which a non-AP STA controlled by an AP is made a relay STA, and as in the present disclosure, specific settings for information representing a relay frame and an address field need to be newly defined. By performing signal transmission to an STA using a relay through the proposed method in the present disclosure, the influence of range and obstacles can be reduced, and the received SNR of the STA can be improved, thereby achieving a technical effect of reducing latency and improving throughput for signal transmission.

Embodiments described above are that elements and features of the present disclosure are combined in a predetermined form. Each element or feature should be considered to be optional unless otherwise explicitly mentioned. Each element or feature may be implemented in a form that it is not combined with other element or feature. In addition, an embodiment of the present disclosure may include combining a part of elements and/or features. An order of operations described in embodiments of the present disclosure may be changed. Some elements or features of one embodiment may be included in other embodiment or may be substituted with a corresponding element or a feature of other embodiment. It is clear that an embodiment may include combining claims without an explicit dependency relationship in claims or may be included as a new claim by amendment after application.

It is clear to a person skilled in the pertinent art that the present disclosure may be implemented in other specific form in a scope not going beyond an essential feature of the present disclosure. Accordingly, the above-described detailed description should not be restrictively construed in every aspect and should be considered to be illustrative. A scope of the present disclosure should be determined by reasonable construction of an attached claim and all changes within an equivalent scope of the present disclosure are included in a scope of the present disclosure.

A scope of the present disclosure includes software or machine-executable commands (e.g., an operating system, an application, a firmware, a program, etc.) which execute an operation according to a method of various embodiments in a device or a computer and a non-transitory computer-readable medium that such a software or a command, etc. are stored and are executable in a device or a computer. A command which may be used to program a processing system performing a feature described in the present disclosure may be stored in a storage medium or a computer-readable storage medium and a feature described in the present disclosure may be implemented by using a computer program product including such a storage medium. A storage medium may include a high-speed random-access memory such as DRAM, SRAM, DDR RAM or other random-access solid state memory device, but it is not limited thereto, and it may include a nonvolatile memory such as one or more magnetic disk storage devices, optical disk storage devices, flash memory devices or other nonvolatile solid state storage devices. A memory optionally includes one or more storage devices positioned remotely from processor(s). A memory or alternatively, nonvolatile memory device(s) in a memory include a non-transitory computer-readable storage medium. A feature described in the present disclosure may be stored in any one of machine-readable mediums to control a hardware of a processing system and may be integrated into a software and/or a firmware which allows a processing system to interact with other mechanism utilizing a result from an embodiment of the present disclosure. Such a software or a firmware may include an application code, a device driver, an operating system and an execution environment/container, but it is not limited thereto.

A method proposed by the present disclosure is mainly described based on an example applied to an IEEE 802.11-based system, 5G system, but may be applied to various WLAN or wireless communication systems other than the IEEE 802.11-based system.

1. A method comprising:
by a first station (STA), performing negotiation with an access point (AP) for relay transmission;
by the first STA, receiving, from the AP, a data frame targeting one or more second STAs; and
by the first STA, transmitting the data frame to the one or more second STAs,
wherein a medium access control (MAC) header in the data frame includes information for that the data frame is transmitted and received through a relay, and
wherein at least one of a plurality of address fields included in the MAC header is set to identification information for the first STA.

2. The method of claim 1,
wherein the information is indicated by a combination of a Type value and a Subtype value in the Type and Subtype subfields in the MAC header.

3. The method of claim 2,
wherein the Type value is set to 10, and
wherein the Subtype value is set to one of 0001, 0010, 0011, 0101, 0110, or 0111.

4. The method of claim 2,
wherein the Subtype value is set differently in a case that the data frame targets one second STA and in a case that the data frame targets a plurality of second STAs.

5. The method of claim 1,
wherein, based on a value of a To DS subfield in the MAC header being set to 1 and a value of a From DS subfield being set to 1, the plurality of address fields include a first address field, a second address field, a third address field, and a fourth address field,
wherein the first address field is set to identification information for the first STA,
wherein the second address field is set to identification information for the AP,
wherein the third address field is set to identification information for a single second STA or identification information for a group to which a plurality of second STAs belong, and
wherein the fourth address field is set to identification information for the AP.

6. The method of claim 1,
wherein, based on a value of a To DS subfield in the MAC header being set to 0 and a value of a From DS subfield being set to 1, the plurality of address fields include a first address field, a second address field, and a third address field,
wherein the first address field is set to identification information for the first STA,
wherein the second address field is set to identification information for the AP, and
wherein the third address field is set to identification information for a group to which a plurality of second STAs belong or identification information for a single second STA.

7. The method of claim 1,
wherein the data frame is constructed based on an aggregated-MAC service data unit (A-MSDU) constructed with one or more subframes.

8. The method of claim 7,
wherein, based on that the data frame targets a plurality of second STAs, the data frame further includes a specific field including information for the plurality of second STAs prior to the A-MSDU.

9. The method of claim 8,
wherein the information for the plurality of second STAs includes at least one of a number of second STAs, identification information for each second STA belonging to the plurality of second STAs, a number of subframes included in the A-MSDU, a number of subframes allocated to each second STA belonging to the plurality of second STAs, or information indicating a presence or absence of a source address (SA) field.

10. The method of claim 7,
wherein a destination address (DA) field of each subframe belonging to the A-MSDU is set to identification information for the second STA, and a source address (SA) field is set to identification information for the AP.

11. The method of claim 1,
wherein the data frame is constructed based on an aggregated-MAC protocol data unit (A-MPDU) constructed with one or more subframes, and
wherein each subframe belonging to the A-MPDU includes the MAC header and a MAC service data unit (MSDU).

12. The method of claim 11,
wherein a destination address (DA) field of the MSDU is set to identification information for a second STA targeted by the subframe or identification information for a group to which a plurality of second STAs belong, and a source address (SA) field is set to identification information for an AP.

13. The method of claim 11,
wherein each subframe belonging to the A-MPDU further includes 1-bit information indicating whether the A-MPDU targets a single second STA or a plurality of second STAs.

14. The method of claim 1,
wherein the first STA corresponds to a non-AP STA controlled by the AP for relay transmission.

15. The method of claim 1,
wherein performing the negotiation for the relay transmission support includes receiving capability information for the relay transmission, and
wherein the capability information includes one or more of identification information of the relay STA, information for whether a relay is in operation, a maximum number of relay-supporting STAs, information for a relay mode, or information for whether four address fields in a MAC header are supported.

16. An apparatus comprising:
at least one transceiver; and
at least one processor connected to the at least one transceiver,
wherein the at least one processor is configured to:
by a first station (STA), perform negotiation with an access point (AP) for relay transmission;
by the first STA, receive, from the AP, a data frame targeting one or more second STAs; and
by the first STA, transmit the data frame to the one or more second STAs,
wherein a medium access control (MAC) header in the data frame includes information for that the data frame is transmitted and received through a relay, and
wherein at least one of a plurality of address fields included in the MAC header is set to identification information for the first STA.

17. (canceled)

18. An apparatus comprising:
at least one transceiver; and
at least one processor connected to the at least one transceiver,
wherein the at least one processor is configured to:
by an access point (AP), perform negotiation with a first station (STA) for relay transmission;
by the AP, construct a data frame targeting one or more second STAs, for the relay transmission; and
by the AP, transmit the data frame to the first STA,
wherein a medium access control (MAC) header in the data frame includes information for that the data frame is transmitted and received through a relay, and
wherein at least one of a plurality of address fields included in the MAC header is set to identification information for the first STA.

19-20. (canceled)
